(19) United States
(12) Patent Application Publication
(10) Pub. No.: US 2026/0143518 A1
(43) Pub. Date: May 21, 2026

(54) REALLOCATION OF RANDOM ACCESS CHANNEL OCCASIONS FOR FULL DUPLEX OPERATIONS

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Jae Ho RYU, San Diego, CA (US)

(21) Appl. No.: 18/952,060

(22) Filed: Nov. 19, 2024

(51) Int. Cl. H04W 74/00; H04L 5/14; H04W 74/0833

(52) U.S. Cl. CPC H04W 74/002; H04L 5/14; H04W 74/0833

(57) ABSTRACT

Various aspects of the present disclosure generally relate to wireless communication. Some aspects more specifically relate to a user equipment (UE) mapping a first set of random access channel (RACH) occasions (ROs) associated with half duplex operations to a set of synchronization signal blocks (SSBs) and identifying a subset of ROs from the first set of ROs that are not mapped during the mapping of the first set of ROs. The UE may reallocate one or more ROs of the subset of ROs from the first set of ROs to a second set of ROs associated with full duplex operations. In accordance with reallocating the one or more ROs, the UE may map the second set of ROs associated with full duplex operations to the set of SSBs. That is, the one or more ROs reallocated to the second set of ROs may be mapped to the set of SSBs.

### FIELD OF THE DISCLOSURE

Aspects of the present disclosure generally relate to wireless communication and specifically relate to techniques, apparatuses, and methods associated with reallocation of random access channel (RACH) occasions (ROs) for full duplex operations.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples of a wireless communication network, a user equipment (UE) may perform a random-access channel (RACH) procedure to establish a wireless connection with a network node. For example, a network node may transmit, to the UE, a physical random-access channel (PRACH) configuration that indicates a set of RACH occasions (ROs). In some examples, an RO may be an indicated time interval and/or set of frequency and time resources during which the UE may transmit a PRACH preamble to initiate a connection or reestablish synchronization with the network node. Additionally, the UE may map a set of synchronization signal blocks (SSBs) associated with the network node to one or more ROs of the set of ROs (in accordance with one or more SSB-to-RO mapping rules). For example, an SSB is a type of signal that the network node may transmit periodically, and includes a combination of synchronization signals and broadcast information that aids in the initial access and a beam selection process. An SSB may include a primary synchronization signal (PSS), a secondary synchronization signal (SSS), and a physical broadcast channel (PBCH). The UE may use the PSS and the SSS to establish frequency and time synchronization with the network node, and the PBCH may indicate system information that assists the UE in identifying and connecting to the network node. In some examples, an SSB index is indicated in a physical downlink control channel (PDCCH) order that triggers a RACH procedure. In some other examples, such as when the RACH procedure is triggered at the UE, the UE may select the SSB index (for example, from a set of SSB indexes indicated in system information or a serving cell configuration). In accordance with the SSB index indicated in the PDCCH order or the SSB index selected by the UE, the UE may determine which ROs are available to use for the PRACH transmission.

### SUMMARY

Some aspects described herein relate to a user equipment (UE) for wireless communication. The UE may include a processing system that includes one or more processors and one or more memories coupled with the one or more processors. The processing system may be configured to cause the UE to receive, from a network node, configuration information that indicates a first set of random access channel (RACH) occasions (ROs) associated with half duplex operations and a set of synchronization signal block (SSB) indexes. The processing system may be configured to cause the UE to map the set of SSB indexes to a first subset of ROs of the first set of ROs in accordance with the half duplex operations. The processing system may be configured to cause the UE to transmit, during at least one RO of the first set of ROs, a RACH message in accordance with full duplex operations in accordance with the at least one RO not being included in the first subset of ROs mapped to the set of SSB indexes.

Some aspects described herein relate to a method of wireless communication performed by a UE. The method may include receiving, from a network node, configuration information that indicates a first set of ROs associated with half duplex operations and a set of SSB indexes. The method may include mapping the set of SSB indexes to a first subset of ROs of the first set of ROs in accordance with the half duplex operations. The method may include transmitting, during at least one RO of the first set of ROs, a RACH message in accordance with full duplex operations in accordance with the at least one RO not being included in the first subset of ROs mapped to the set of SSB indexes.

Some aspects described herein relate to an apparatus for wireless communication. The apparatus may include means for receiving, from a network node, configuration information that indicates a first set of ROs associated with half duplex operations and a set of SSB indexes. The apparatus may include means for mapping the set of SSB indexes to a first subset of ROs of the first set of ROs in accordance with the half duplex operations. The apparatus may include means for transmitting, during at least one RO of the first set of ROs, a RACH message in accordance with full duplex operations in accordance with the at least one RO not being included in the first subset of ROs mapped to the set of SSB indexes.

Some aspects described herein relate to a non-transitory computer-readable medium that stores a set of instructions for wireless communication by a UE. The set of instructions, when executed by one or more processors of the UE, may cause the UE to receive, from a network node, configuration information that indicates a first set of ROs associated with half duplex operations and a set of SSB indexes. The set of instructions, when executed by one or more processors of the UE, may cause the UE to map the set of SSB indexes to a first subset of ROs of the first set of ROs in accordance with the half duplex operations. The set of instructions, when executed by one or more processors of the UE, may cause the UE to transmit, during at least one RO of the first set of ROs, a RACH message in accordance with full duplex operations in accordance with the at least one RO not being included in the first subset of ROs mapped to the set of SSB indexes.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating examples of full duplex communication in accordance with the present disclosure.

FIG. 4 is a diagram illustrating examples of full duplex deployments in accordance with the present disclosure.

FIG. 5A is a diagram illustrating examples of different duplexing modes in accordance with the present disclosure.

FIG. 5B is a diagram illustrating an example of sub-band full duplex (SBFD) activation in accordance with the present disclosure.

FIG. 6 is a diagram illustrating an example of a four-step random access procedure in accordance with the present disclosure.

FIG. 7 is a diagram illustrating an example of a two-step random access procedure in accordance with the present disclosure.

FIG. 8 is a diagram illustrating an example of a synchronization signal (SS) hierarchy in accordance with the present disclosure.

FIG. 9 is a diagram illustrating an example of a random access channel (RACH) configuration using a shared physical RACH (PRACH) configuration index for half duplex and full duplex operations in accordance with the present disclosure.

FIG. 10A is a diagram illustrating an example of an SS block (SSB) to RACH occasion (RO) mapping without reallocating unmapped ROs for full duplex operations in accordance with the present disclosure.

FIG. 10B is a diagram illustrating an example associated with reallocating unmapped ROs for full duplex operations in accordance with the present disclosure.

FIG. 11 is a diagram illustrating an example associated with reallocating unmapped ROs for full duplex operations in accordance with the present disclosure.

FIG. 12 is a flowchart illustrating an example process performed, for example, at a user equipment (UE) or an apparatus of a UE that supports reallocation of ROs for full duplex operations in accordance with the present disclosure.

FIG. 13 is a diagram of an example apparatus for wireless communication that supports reallocation of ROs for full duplex operations in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of a wireless communication network, a user equipment (UE) may perform a random-access channel (RACH) procedure to establish a wireless connection with a network node. For example, a network node may transmit to the UE a physical random-access channel (PRACH) configuration that indicates a set of RACH occasions (ROs). In some examples, an RO may be an indicated time interval and/or set of frequency and time resources during which the UE may transmit a PRACH preamble to initiate a connection or reestablish synchronization with the network node. Additionally, the UE may map a set of synchronization signal blocks (SSBs) associated with the network node to one or more ROs of the set of ROs (in accordance with an RO-to-SSB mapping protocol). For example, an SSB may be a type of signal structure that the network node may transmit periodically and includes a combination of synchronization signals and broadcast information that aids in the initial access and a beam selection process. An SSB may include a primary synchronization signal (PSS), a secondary synchronization signal (SSS), and a physical broadcast channel (PBCH). The UE may use the PSS and SSS to establish frequency and time synchronization with the network node, and the PBCH may indicate system information, including the SSB index and beam-specific parameters that assist the UE in identifying and connecting to the beam associated with the SSB. Therefore, the UE may use SSB-to-RO mapping rules (for example, included in the RO-to-SSB mapping protocol) to map one or more SSBs to one or more ROs. In some examples, an SSB index is indicated in a physical downlink control channel (PDCCH) order that triggers a RACH procedure. In some other examples, such as when the RACH procedure is triggered at the UE, the UE may select the SSB index (for example, from a set of SSB indexes indicated in system information or a serving cell configuration). In accordance with the SSB index indicated in the PDCCH order or the SSB index selected by the UE, the UE may determine which ROs are available to use for the PRACH transmission.

In some examples, the PRACH configuration may indicate different sets of ROs that are associated with different types of wireless communication symbols. For example, the PRACH configuration may indicate a first set of ROs that are configured for half duplex operations (such as during uplink symbols or flexible symbols). Additionally, the PRACH configuration may indicate a second set of ROs that are configured for full duplex operations (such as during full duplex symbols that include both uplink and downlink resources). In other words, the second set of ROs may be associated with full duplex symbols (such as sub-band full duplex (SBFD) symbols), which support concurrent uplink and downlink transmissions by the network node within the same frequency band.

In accordance with the first set of ROs (associated with half duplex symbols) and the second set of ROs (associated with full duplex symbols), the UE may perform respective mappings for a set of SSBs. For example, over a number of SSB to PRACH occasion mapping cycles within an association period, the UE may map the set of SSBs to one or more ROs of the first set of ROs. In some cases, however, after each SSB of the set of SSBs is mapped to the first set of ROs, there may be a subset of ROs of the first set of ROs that are not mapped to any SSB. For example, one or more ROs may be unmapped in cases when the number of SSBs to be mapped within the association period is less than the number of ROs in the first set of ROs. In such examples, the UE may not transmit a PRACH preamble during the subset of ROs that are not mapped to the set of SSBs. Therefore, the frequency and time resources associated with the non-mapped ROs may go unused by the UE, which may decrease resource efficiency. Additionally, because the unmapped ROs are unavailable to use to transmit the PRACH preamble, a duration until a next valid RO in which the UE can transmit the PRACH preamble may increase, which may increase latency associated with performing the RACH procedure.

Various aspects relate generally to reallocating unmapped ROs from a first set of ROs associated with half duplex operations for use by the UE in full duplex operations. Some aspects more specifically relate to the UE mapping a set of SSBs to one or more ROs of a first set of ROs associated with half duplex operations and identifying a subset of ROs, from the first set of ROs, that are not mapped during the mapping of the first set of ROs. In accordance with identifying the subset of ROs, the UE may reallocate one or more ROs of the subset of ROs from the first set of ROs to a second set of ROs associated with full duplex operations. In accordance with reallocating the one or more ROs, the UE may map the set of SSBs to the second set of ROs associated with full duplex operations. In other words, the one or more ROs reallocated to the second set of ROs may be mapped to the set of SSBs, in addition to any ROs originally configured for full duplex operations. In some aspects, the network node may transmit signaling to the UE that enables the UE to reallocate the subset of ROs that are not mapped. In some aspects, the UE may determine whether to reallocate the subset of ROs in accordance with an RO periodicity indicated in the PRACH configuration satisfying a threshold. In some aspects, the UE may determine the one or more ROs that are reallocated to the second set of ROs in accordance with a type of slot the one or more ROs reside within. For example, the UE may determine to reallocate non-mapped ROs from the first set of ROs that are associated with one or more of an uplink slot, a flexible half duplex slot, or a flexible full duplex slot.

Particular aspects of the subject matter described in this disclosure can be implemented to realize one or more of the following potential advantages. In some examples, the described techniques can be used to reduce unused time and frequency resources. For example, by reallocating non-mapped ROs from the first set of ROs to the second set of ROs, the UE may map the set of SSBs to the previously non-mapped ROs, which may reduce the number of unused ROs. Additionally, by reallocating non-mapped ROs to the second set of ROs, a number of ROs in the second set of ROs per PRACH occasion mapping cycle may increase, which may decrease the number of PRACH occasion mapping cycles per association period. Additionally, by reallocating non-mapped ROs, the UE may transmit a PRACH preamble earlier during one of the reallocated ROs, which may reduce latency associated with the RACH procedure.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (cMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

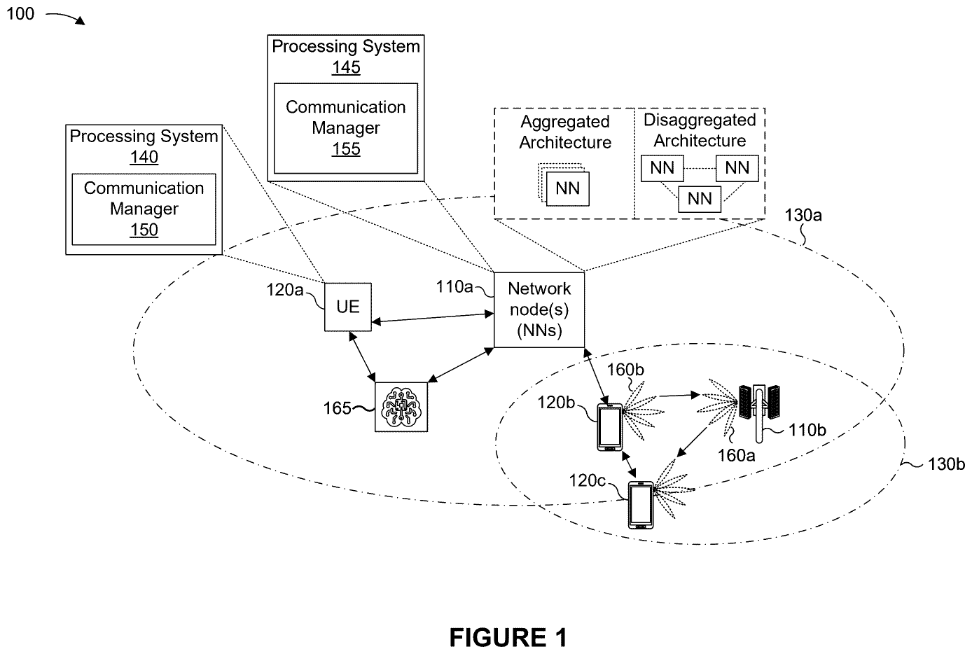

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, in accordance with user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FRI is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FRI, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. In some examples, the processing system 145 may include a communication manager 155.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

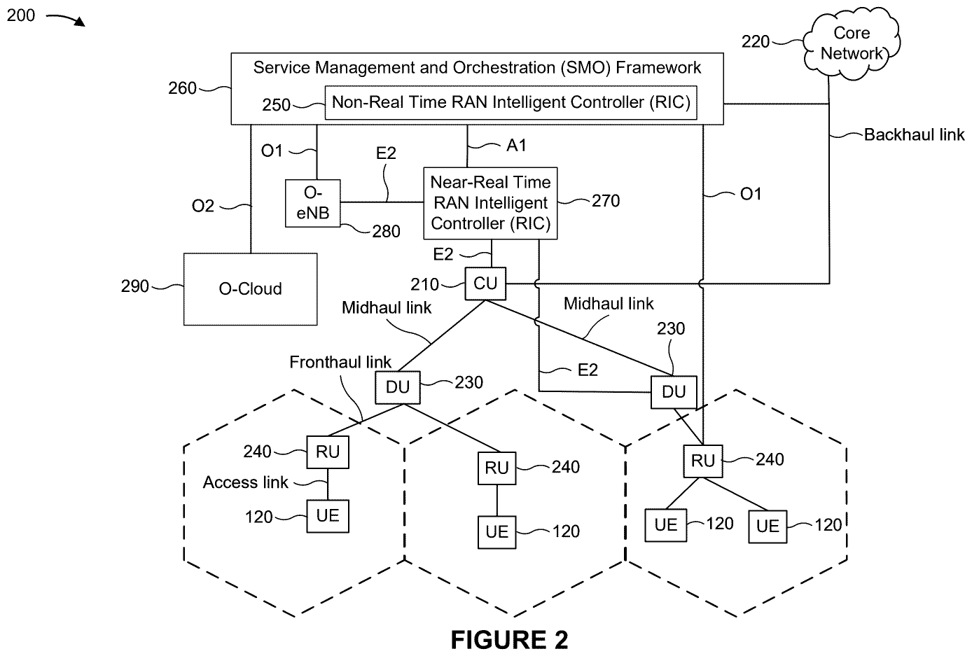

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the number of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a PSS, an SSS, an SSB (for example, that includes a PSS, an SSS, and a PBCH), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder in accordance with, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) number of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified in accordance with, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive, from a network node, configuration information that indicates a first set of ROs associated with half duplex operations and a set of SSB indexes; map the set of SSB indexes to a first subset of ROs of the first set of ROs in accordance with the half duplex operations; and transmit, during at least one RO of the first set of ROs, a RACH message in accordance with full duplex operations in accordance with the at least one RO not being included in the first subset of ROs mapped to the set of SSB indexes. Additionally or alternatively, the communication manager 150 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-cNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

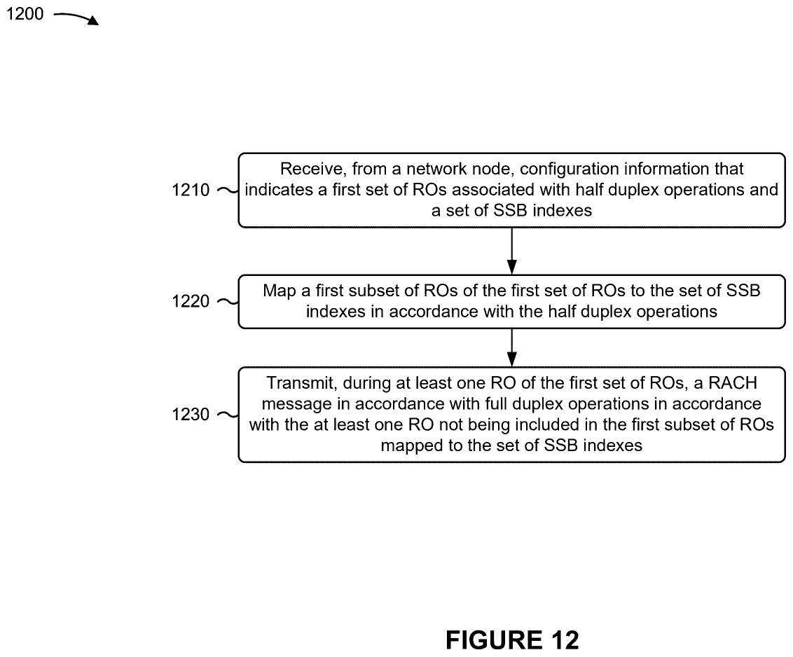

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with reallocation of ROs for full duplex operations, as described in more detail elsewhere herein. For example, the processing system 145 of the network node 110, the processing system 140 of the UE 120, the CU 210, the DU 230, or the RU 240 may perform or direct operations of, for example, process 1200 of FIG. 12, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1200 of FIG. 12, or other processes as described herein. In some examples, executing instructions may include running the instructions, converting the instructions, compiling the instructions, and/or interpreting the instructions, among other examples.

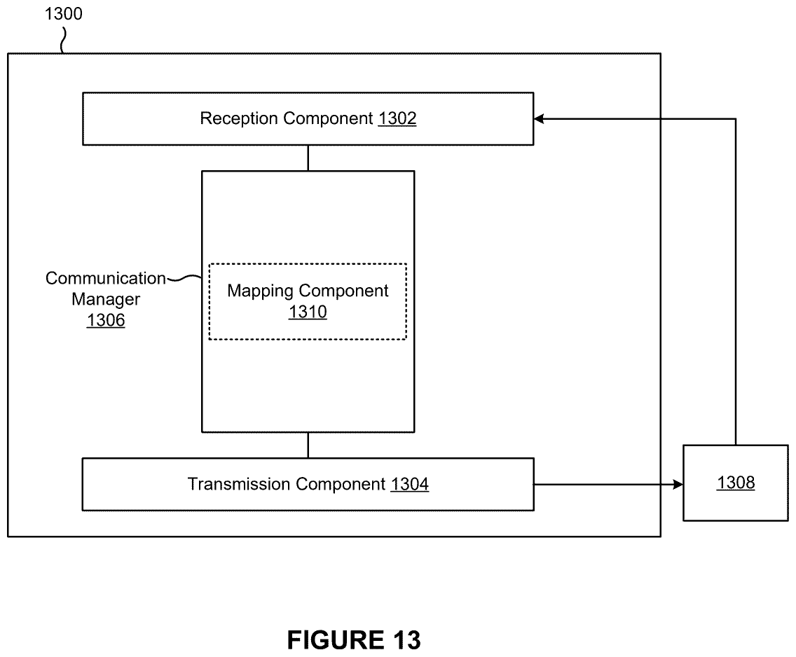

In some aspects, the UE 120 includes means for receiving, from a network node, configuration information that indicates a first set of ROs associated with half duplex operations and a set of SSB indexes; means for mapping the set of SSB indexes to a first subset of ROs of the first set of ROs in accordance with the half duplex operations; and/or means for transmitting, during at least one RO of the first set of ROs, a RACH message in accordance with full duplex operations in accordance with the at least one RO not being included in the first subset of ROs mapped to the set of SSB indexes. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), and/or a transmission component (for example, transmission component 1304 depicted and described in connection with FIG. 13), among other examples.

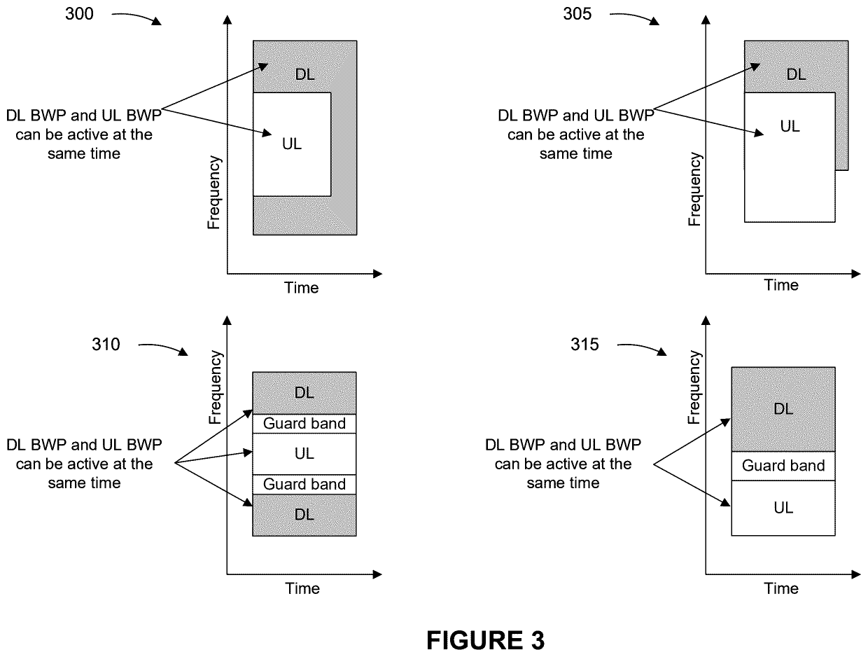

FIG. 3 is a diagram illustrating examples 300, 305, 310, and 315 of full duplex communication in accordance with the present disclosure. As described herein, “full duplex communication” refers to simultaneous uplink and downlink communication in a wireless network, which may be a capability of a UE, a network node, or another suitable device (for example, a mobile termination (MT) component and/or a forwarding (FWD) component of a network-controlled repeater (NCR)). For example, a UE operating in a full duplex mode may transmit an uplink communication and receive a downlink communication at the same time (for example, in the same slot or the same symbol), and a network node operating in a full duplex mode may receive an uplink communication and transmit a downlink communication at the same time. “Half duplex communication” in a wireless network refers to unidirectional communications (for example, only downlink communication or only uplink communication) at a given time (for example, a device only transmits or only receives in a given slot or a given symbol). In some examples, one or more nodes in a wireless network may support full duplex communication and half duplex communication, and other nodes may support half duplex communication only. For example, in some examples, a network node may support full duplex and half duplex communication, and one or more UEs may support half duplex communication only.

As shown in FIG. 3, examples 300 and 305 show examples of in-band full duplex (IBFD) communication. In a scenario where a network node supports IBFD and a UE supports half duplex communication only, the network node may receive an uplink communication from a first UE and may transmit a downlink communication to a second UE on the same time and frequency resources. As shown in example 300, in a first example of IBFD, the time and frequency resources for uplink communication may fully overlap with the time and frequency resources for downlink communication (for example, all time and frequency resources allocated to uplink communication are also available for downlink communication). As shown in example 305, in a second example of IBFD, the time and frequency resources for uplink communication may partially overlap with the time and frequency resources for downlink communication (for example, some time and frequency resources are reserved for uplink communication only).

As further shown in FIG. 3, examples 310 and 315 show examples of SBFD communication, which may also be referred to as “sub-band frequency division duplex (SBFDD),” “flexible duplex,” or “FDD in unpaired spectrum.” In some examples, an SBFD communication mode may be supported by a network node only, by a network node and a UE, by a UE only, and/or any suitable combination thereof. In the SBFD communication mode, a node operating in accordance with an SBFD configuration may simultaneously transmit and receive different communications at the same time, but on different frequency resources. For example, a network node operating in an SBFD mode may simultaneously receive an uplink communication from a first UE in an uplink sub-band and transmit a downlink communication to a second UE in a downlink sub-band, where the uplink sub-band and the downlink sub-band may occupy different frequency resources. Similarly, a UE operating in an SBFD mode may simultaneously transmit an uplink communication to a network node in an uplink sub-band and receive a downlink communication from the network node in a downlink sub-band. For example, the uplink sub-band and the downlink sub-band may be sub-bands of a frequency band, such as a time division duplex (TDD) band, or a component carrier of a frequency band. In such examples, the frequency resources used for downlink communication may be separated from the frequency resources used for uplink communication, in the frequency domain, by one or more guard bands. For example, as shown in example 310, SBFD communication may be configured in a D+U+D pattern, where an uplink sub-band is configured between a first (upper) downlink sub-band and a second (lower) downlink sub-band, with a first guard band separating the uplink sub-band from the first downlink sub-band and a second guard band separating the uplink sub-band from the second downlink sub-band. Additionally or alternatively, as shown in example 315, SBFD communication may be configured in a D+U pattern, where a component carrier bandwidth or frequency band is partitioned into a downlink sub-band and an uplink sub-band that are separated by a guard band.

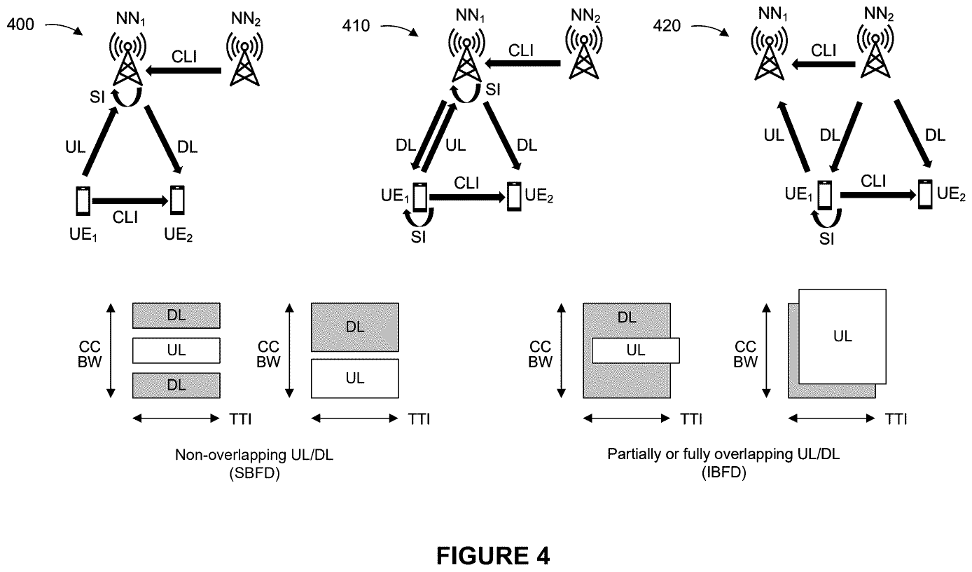

FIG. 4 is a diagram illustrating examples 400, 410, 420 of full duplex deployments in accordance with the present disclosure. As shown in FIG. 4, examples 400, 410, 420 include one or more UEs in communication with one or more network nodes in a wireless network that supports full duplex communication. In general, as described herein, utilizing a full duplexing communication mode may provide reduced latency by allowing a downlink transmission to occur in an uplink-only symbol or slot and/or by allowing an uplink transmission to occur in a downlink-only or flexible symbol or slot. In addition, full duplex communication may increase an uplink duty cycle, which may improve uplink coverage, may enhance spectral efficiency or throughput per cell or per UE, may increase system capacity, may enable more efficient resource utilization by simultaneously utilizing time and frequency resources for downlink and uplink communication, and/or may enable flexible and dynamic uplink and downlink resource adaptation according to uplink and/or downlink traffic patterns. However, as described in further detail herein, full duplexing communication modes may be associated with dynamic interference conditions.

For example, as shown in FIG. 4, example 400 includes a first UE (shown as UE1) and a second UE (shown as UE2) in communication with a first network node (shown as NN1) operating in a full duplexing mode, with the first UE and the second UE operating in a half duplexing mode. For example, as shown in FIG. 4, the first UE may transmit one or more uplink transmissions to the first network node, and the second UE may concurrently receive one or more downlink transmissions from the first network node. Accordingly, in example 400, the first network node is operating in a full duplexing mode, and the first UE and the second UE are each operating in a half duplexing mode. As shown by example 400, there may be various forms of interference that may degrade downlink reception performance at one or more UEs and/or uplink reception performance at the first network node operating in the full duplexing mode. For example, as shown, the first network node may experience cross-link interference (CLI) caused by downlink transmissions from a second network node (shown as NN2) that may be located in an adjacent or nearby cell. Furthermore, as shown, the uplink transmission from the first UE to the first network node may cause CLI at the second UE (for example, CLI that interferes with downlink reception at the second UE). Furthermore, as shown, the first network node may experience self-interference, where the downlink transmission to the second UE interferes with reception of the uplink transmission from the first UE. For example, as described herein, self-interference may generally occur when a transmitted signal leaks into a receive port and/or when an object in a surrounding environment reflects a transmitted signal back to a receive port (for example, causing a clutter echo effect), thus interfering with reception of a desired signal at the receive port. In general, the full duplexing mode used by the first network node in example 400 may be an SBFD mode, where a component carrier bandwidth is divided into an uplink sub-band and one or more downlink sub-bands that are separated by one or more guard bands. Additionally or alternatively, the full duplexing mode may be an IBFD mode, where uplink and downlink resources fully or partially overlap.

As further shown in FIG. 4, in example 410, a first UE may communicate with a first network node in a full duplexing mode. For example, in example 410, the first UE may receive one or more downlink transmissions from the first network node, and the first UE may concurrently transmit one or more uplink transmissions to the first network node. Accordingly, in example 410, the first network node and the first UE are both operating in a full duplexing (for example, SBFD or IBFD) mode. Furthermore, as shown, the first network node may be communicating with a second UE operating in a half duplexing mode. As shown by example 410, the first UE may experience self-interference, where the uplink transmission to the first network node interferes with reception of the downlink transmission from the first network node, and the first UE may cause CLI at the second UE, where the uplink transmission to the first network node interferes with downlink reception at the second UE. Additionally, in example 410, the first network node may experience CLI caused by one or more downlink transmissions from a second network node interfering with reception of the uplink transmission from the first UE, and the first network node may experience self-interference, where downlink transmission(s) to the first UE and/or the second UE interferes with reception of the uplink transmission from the first UE. In example 410, the full duplex communication may be performed in an SBFD mode or an IBFD mode.

As further shown in FIG. 4, in example 420, a first UE may communicate with a first network node and a second network node in a full duplexing mode (for example, a multi-TRP mode). For example, in example 420, the first UE may transmit one or more uplink transmissions to the first network node (for example, a first TRP), and the first UE may concurrently receive one or more downlink transmissions from the second network node (for example, a second TRP). Accordingly, in example 420, the first UE is operating in a full duplexing mode, and the first and second network nodes are both operating in a half duplexing mode. As shown by example 420, the first UE may experience self-interference, where the uplink transmission to the first network node interferes with reception of the downlink transmission from the second network node. Furthermore, the uplink transmission by the first UE may cause CLI at a second UE receiving a downlink transmission from the second network node. Furthermore, as shown, the downlink transmission by the second network node may cause CLI that interferes with uplink reception at the first network node. In example 420, the full duplex communication may be performed in an SBFD mode or an IBFD mode.

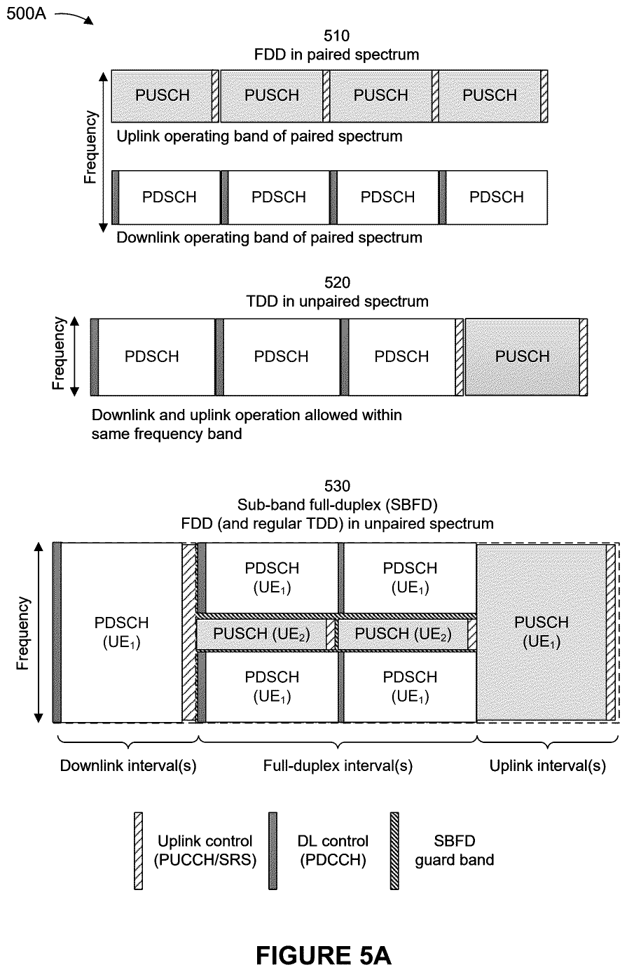

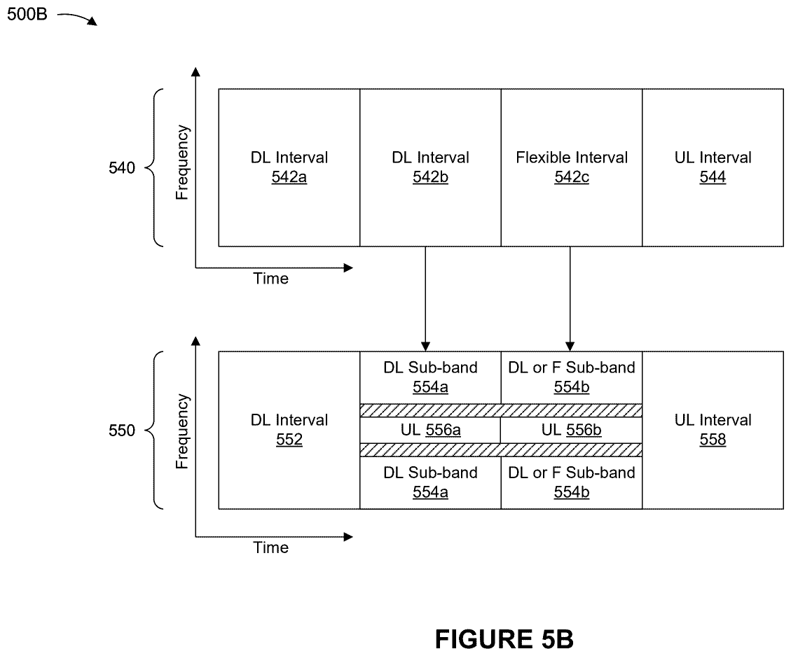

FIG. 5A is a diagram illustrating examples 500A of different duplexing modes in accordance with the present disclosure, and FIG. 5B is a diagram illustrating an example 500B of SBFD activation in accordance with the present disclosure. For example, as described in further detail herein, FIG. 5A illustrates an example 510 of a frequency division duplex (FDD) mode that may be used in paired spectrum, an example 520 of a TDD mode that may be used in unpaired spectrum, and an example 530 of an SBFD mode that may be used in unpaired spectrum, and FIG. 5B illustrates an example 500B of techniques that may be used to activate the SBFD mode.

In some examples, a wireless communication standard and/or governing body may generally specify one or more duplexing modes in which a wireless spectrum is to be used. For example, 3GPP may specify how wireless spectrum is to be used for a RAT and/or air interface. As an example, a specification may indicate whether a band is to be used as paired spectrum in an FDD mode, as unpaired spectrum in a TDD mode, or another duplexing mode (for example, SBFD).

For example, as shown by example 510, paired spectrum in the FDD mode may use a first frequency region (or channel) for uplink communication and a second frequency region (or channel) for downlink communication. In such cases, the frequency regions or channels used for uplink communication and downlink communication do not overlap, have different center frequencies, and have sufficient separation to prevent interference between the downlink communication and the uplink communication. For example, paired spectrum in FDD mode may include an uplink operating band and a downlink operating band that are configured to use non-overlapped frequency regions separated by a guard band. Accordingly, when operating in the FDD mode in paired spectrum, a network node or a UE with full duplex capabilities may perform concurrent transmit and receive operations using the separate operating bands allocated to downlink and uplink communication. For example, paired bands in NR include NR operating bands n1, n2, n3, n5, n7, n8, n12, n20, n25, and n28, as specified by 3GPP Technical Specification (TS) 38.101-1.

Alternatively, as shown by example 520, unpaired spectrum in the TDD mode may allow downlink and uplink operation within a single frequency region (for example, a single operating band). For example, when operating in TDD mode in unpaired spectrum, downlink communication and uplink communication may occur in the same frequency resources. Some deployments may use TDD or a legacy half duplexing mode in the unpaired band, whereby some TTIs (for example, frames, slots, and/or symbols) are used for downlink communication only and other TTIs are used for uplink communication only. In such examples, substantially the entire bandwidth of a component carrier may be used for downlink communication or uplink communication, depending on whether the communication is performed in a downlink-only interval, an uplink-only interval, or a flexible interval (in which either downlink or uplink communication can be scheduled). Examples of unpaired bands include NR operating bands n40, n41, and n50, as specified by 3GPP TS 38.101-1. In some examples, however, using TDD in unpaired spectrum may be inefficient. For example, uplink transmit power may be limited, meaning that UEs may be incapable of transmitting with enough power to efficiently utilize the full component carrier bandwidth in an uplink interval. This may be particularly problematic in large cells at the cell edge. Furthermore, using TDD may introduce latency relative to a full duplexing scheme in which uplink communications and downlink communications can be performed in the same time interval, because TDD restricts usage of a given TTI to uplink-only or downlink-only. Furthermore, using TDD may reduce spectral efficiency and/or reduce throughput by restricting usage of a given TTI to uplink-only or downlink-only.

Accordingly, as shown by example 530, an unpaired band may be configured in a full duplexing mode to enable concurrent transmit and receive operations in unpaired spectrum (for example, a TDD band). For example, in FIG. 5A, example 530 depicts an SBFD mode, which may be referred to as full duplexing in a frequency division multiplexing (FDM) mode or other suitable terminology, in order to enable TDD operation and/or FDD operation in unpaired spectrum. For example, as shown in FIG. 5A, an unpaired band configured in the SBFD mode may associate one or more TTIs with downlink communication only (for example, “D” slots), one or more TTIs for uplink communication only (for example, “U” slots), and one or more TTIs for both downlink communication and uplink communication (for example, “D+U” slots). Each TTI may be associated with a control region, illustrated as a portion of a time interval with a diagonal fill for uplink control (for example, a PUCCH) or a darker-shaded fill for downlink control (for example, a PDCCH). Additionally or alternatively, each TTI may be associated with a data region, which is shown as a PDSCH for downlink frequency regions or a PUSCH for uplink frequency regions.

In some examples, an unpaired band configured in the SBFD mode may include one or more downlink-only time intervals, one or more uplink-only time intervals, and/or one or more full duplex time intervals (for example, frames, subframes, slots, and/or symbols, among other examples) that are associated with an FDD configuration. For example, as shown in FIG. 5A, the FDD configuration associated with a full duplex time interval may indicate one or more downlink frequency regions (or sub-bands) and one or more uplink frequency regions (or sub-bands) that are separated by a guard band. For example, as shown by example 530, SBFD communication may be configured in a D+U+D pattern, where an uplink sub-band is configured between a first (upper) downlink sub-band and a second (lower) downlink sub-band, with a first guard band separating the uplink sub-band from the first downlink sub-band and a second guard band separating the uplink sub-band from the second downlink sub-band. Additionally or alternatively, SBFD communication may be configured in a D+U pattern (not explicitly shown in FIG. 5A), where a component carrier bandwidth or frequency band is partitioned into a downlink sub-band and an uplink sub-band that are separated by a guard band. Accordingly, an FDD configuration may divide an unpaired frequency band (for example, one or more component carriers of an unpaired band) into uplink frequency regions, downlink frequency regions, and/or other regions (for example, guard bands, and/or control regions), which may enable a network node or a UE with full duplex capabilities to perform simultaneous transmit and receive operations during one or more full duplex time intervals in which frequency resources are divided into downlink and uplink sub-bands with a guard band separation to prevent an uplink transmission from causing self-interference with respect to downlink reception. For example, in a given full duplex time interval, a half duplexing UE may either transmit using the uplink frequency region or receive in the downlink frequency region (for example, a UE communicating in a half duplexing mode may only receive in a downlink frequency region or transmit in an uplink frequency region during the full duplex time intervals). Alternatively, a full duplexing UE may transmit using the uplink frequency region and/or receive in the downlink frequency region. Additionally or alternatively, a full duplexing network node may transmit a downlink communication to a first UE within the downlink frequency regions(s) and simultaneously receive an uplink communication from a second UE in the uplink frequency region(s). In some examples, the FDD configuration may identify BWP configurations corresponding to the uplink frequency regions and the downlink frequency regions. For example, a respective BWP may be configured for each uplink frequency region and each downlink frequency region.

Additionally or alternatively, full duplexing may be enabled in unpaired spectrum in an IBFD mode, which may be referred to herein as full duplexing in a spatial division multiplexing (SDM) mode. For example, in an IBFD mode or a full duplexing in SDM mode, uplink communication may occur on time and frequency resources that fully overlap time and frequency resources allocated to downlink communication (for example, all of the time and frequency resources available for uplink communication are also available for downlink communication). Alternatively, uplink communication may occur on time and frequency resources that partially overlap with time and frequency resources available for downlink communication (for example, some time and frequency resources available for uplink communication are also available for downlink communication and some time and frequency resources available for uplink communication are uplink-only). In general, in the SBFD mode and/or the IBFD mode, full duplex communication may be conditional on sufficient beam separation between an uplink beam and a downlink beam (for example, uplink transmission may be from one antenna panel and downlink reception may be in another antenna panel) in order to minimize self-interference that may occur when a transmitted signal leaks into a receive port and/or when an object in a surrounding environment reflects a transmitted signal back to a receive port (for example, causing a clutter echo effect).

In some examples, as described herein, one or more frequency regions that support SBFD communication may be configured to dynamically switch between operating in a TDD mode (for example, a half duplexing mode in which each slot or symbol is uplink-only or downlink-only, also referred to as duplexing mode 1 and/or a legacy half duplexing mode) and one or more SBFD modes. For example, in a scenario where only a network node supports SBFD operation, one or more downlink or flexible slots or symbols can be semi-statically or dynamically configured in a first SBFD mode (referred to as duplexing mode 2 and/or a network node SBFD mode) in which the network node simultaneously transmits a downlink communication to a first UE in one or more downlink sub-bands and receives an uplink communication from a second UE in an uplink sub-band, and any other slots or symbols may be configured in the legacy half duplexing (for example, downlink-only or uplink-only). Furthermore, in cases where a UE supports SBFD operation, one or more slots or symbols can be configured in a second SBFD mode (referred to as duplexing mode 3 and/or a UE and network node SBFD mode) in which a network node operating in SBFD mode communicates with a UE operating in SBFD mode or in a third SBFD mode (referred to as duplexing mode 4 and/or a UE SBFD mode) in which a UE operating in SBFD mode communicates with a first TRP operating in a half duplexing mode and a second TRP operating in a half duplexing mode. In general, the second and third SBFD modes may be similar from a UE perspective, and may be transparent to an SBFD-capable UE in cases where two TRPs or cells are associated with the same cell or DU. Furthermore, although some examples are described herein in relation to SBFD operation, the same or similar techniques may be applicable to partial or fully overlapping full duplex (for example, IBFD) operation.

For example, as shown in FIG. 5B, a first configuration 540 (for example, a legacy or default configuration associated with the TDD mode) may indicate a first slot format pattern or TDD pattern associated with a half duplex mode (for example, where each interval is downlink-only, uplink-only, or flexible such that the interval can be configured to be a downlink interval or an uplink interval). The first slot format pattern may include one or more downlink intervals (for example, shown as two downlink intervals 542a and 542b), one or more flexible intervals (for example, shown as one flexible interval 542c), and/or one or more uplink intervals (for example, shown as one uplink interval 544). The first slot format pattern may repeat over time. In some examples, a network node 110 may indicate the first slot format pattern to a UE 120 using one or more slot format indicators. A slot format indicator, for a slot, may indicate whether the corresponding slot is an uplink slot, a downlink slot, or a flexible slot (for example, that can be used as an uplink or downlink slot).

A network node 110 may instruct (for example, using an indication, such as an RRC message, a MAC-CE, or a DCI message) a UE 120 to switch from the first configuration 540 to a second configuration 550. As an alternative, the UE 120 may indicate to the network node 110 that the UE 120 is switching from the first configuration 540 to the second configuration 550. The second configuration 550 may indicate a second slot format pattern that repeats over time, similar to the first slot format pattern. In some examples, the UE 120 may switch from the first configuration 540 to the second configuration 550 during a time period (for example, a number of symbols and/or an amount of time) in accordance with an indication received from the network node 110 (for example, before switching back to the first configuration 540). During the time period, the UE 120 may communicate using the second slot format pattern, and then may revert to using the first slot format pattern after the end of the time period. The time period may be indicated by the network node 110 (for example, in the instruction to switch from the first configuration 540 to the second configuration 550, as described above) and/or associated with a programmed and/or otherwise preconfigured rule. For example, the rule may be based on or otherwise associated with a table (for example, defined in 3GPP specifications and/or another wireless communication standard) that associates different SCSs and/or numerologies (for example, represented by a u parameter and associated with corresponding SCSs) with corresponding time periods for switching configurations.

In example 500B, the second slot format pattern includes two SBFD intervals, which include a first SBFD interval in place of downlink interval 542b in the first slot format pattern and a second SBFD interval in place of flexible interval 542c in the first slot format pattern. In example 500B, the second slot format pattern includes a downlink interval 552, which is followed by the first SBFD interval that includes a downlink sub-band (for example, a portion of a frequency allocated for use by the network node 110 and the UE 120, shown as downlink sub-bands 554a) and an uplink sub-band (for example, shown as uplink sub-band 556a). For example, when an interval configured as downlink-only (for example, downlink interval 542b) is switched to or otherwise configured for SBFD operation, uplink transmissions within the uplink sub-band (for example, uplink sub-band 556a) are allowed within the interval, and uplink transmissions outside the uplink sub-band are not allowed within the interval. Furthermore, frequency locations of the downlink sub-band(s) (for example, downlink sub-bands 554a) can be explicitly indicated to the UE 120 or implicitly derived by the UE 120, and downlink reception within the downlink sub-band(s) is allowed in the interval.

As further shown in example 500B, the first SBFD interval is followed by a second SBFD interval, which includes one or more sub-bands that may be configured as downlink sub-bands or flexible sub-bands (for example, shown as sub-bands 554b) and an uplink sub-band (for example, shown as uplink sub-band 556b). For example, when an interval configured as flexible (for example, flexible interval 542c) is switched to or otherwise configured for SBFD operation, uplink transmissions within the uplink sub-band (for example, uplink sub-band 556b) are allowed within the interval, and uplink transmissions outside the uplink sub-band are not allowed within the interval. Alternatively, a set of RBs outside the uplink sub-band 556b may be used for uplink communication, or for downlink communication excluding any guard bands, and a transmission direction for all RBs outside the uplink sub-band 556b is the same within the interval (for example, the UE 120 cannot use separate RBs outside the uplink sub-band 556b for downlink and uplink communication). Furthermore, frequency locations of the downlink sub-band(s) (for example, downlink sub-bands 554b) can be explicitly indicated to the UE 120 or implicitly derived by the UE 120, and downlink reception within the downlink sub-band(s) is allowed in the interval. As further shown, the second SBFD interval is followed by an uplink interval 558.

Accordingly, the UE 120 may operate using the second slot format pattern to transmit an uplink communication in an earlier interval (for example, the second interval in the sequence shown in FIG. 5B) as compared to using the first slot format pattern (for example, the fourth interval in sequence, shown as uplink interval 544). Other examples may include additional or alternative changes. For example, the second configuration 550 may indicate an SBFD interval in place of what was an uplink interval in the first configuration 540 (for example, uplink interval 544). In another example, the second configuration 550 may indicate a downlink interval or an uplink interval in place of what was an SBFD interval in the first configuration 540 (not shown in FIG. 5B). In yet another example, the second configuration 550 may indicate a downlink interval or an uplink interval in place of what was an uplink interval or a downlink interval, respectively, in the first configuration 540.

As described herein, an SBFD interval may generally include a frame, a slot, a symbol, or another TTI in which an SBFD configuration is used. An SBFD configuration may include a frequency resource configuration in which full duplex communication is supported (for example, for both uplink and downlink communications), with one or more frequencies or sub-bands used for uplink communication being separated from one or more frequencies or sub-bands used for downlink communication by a guard band. In some examples, the SBFD configuration may include a single uplink sub-band and a single downlink sub-band separated by a guard band. In some examples, the SBFD configuration may include multiple downlink sub-bands and a single uplink sub-band that is separated from the multiple downlink sub-bands by respective guard bands (for example, as shown in FIG. 5B). In some examples, an SBFD configuration may include multiple uplink sub-bands and a single downlink sub-band that is separated from the multiple uplink sub-bands by respective guard bands. In some examples, the SBFD configurations may include multiple uplink sub-bands and multiple downlink sub-bands, where each uplink sub-band is separated from a downlink sub-band by a guard band. In some examples, operating using an SBFD mode may include activating or using a full duplexing mode in one or more slots, symbols, or other intervals based on or otherwise associated with the one or more intervals having the SBFD configuration. An interval may support the SBFD mode if an uplink bandwidth part and a downlink bandwidth part are permitted to be or are simultaneously active in accordance with an SBFD configuration (for example, with guard band separation).

By switching from the first configuration 540 to the second configuration 550, the network node 110 and/or the UE 120 may experience increased quality and/or reliability of communications. For example, the network node 110 and the UE 120 may experience increased throughput (for example, using a full duplex mode), reduced latency (for example, the UE 120 may be able to transmit an uplink and/or a downlink communication sooner using the second configuration 550 rather than the first configuration 540), increased network resource utilization (for example, by using both downlink frequency resources and uplink frequency resources simultaneously instead of only the downlink frequency resources or the uplink frequency resources), improved uplink coverage, and/or flexible and dynamic uplink and downlink resource adaptation according to uplink and downlink traffic patterns, among other examples.

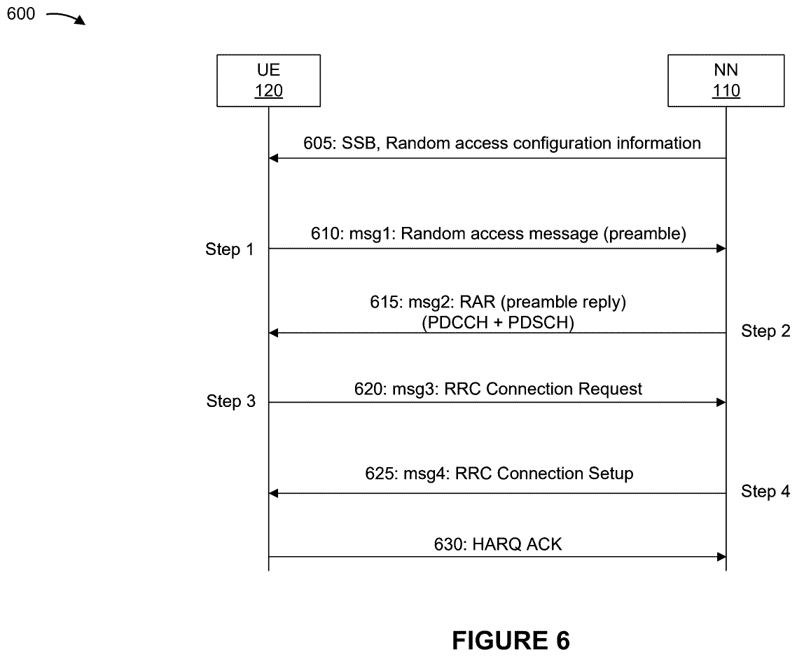

FIG. 6 is a diagram illustrating an example 600 of a four-step random access procedure in accordance with the present disclosure. As shown in FIG. 6, a network node 110 and a UE 120 may communicate with one another to perform the four-step random access procedure.

In a first operation 605, the network node 110 may transmit, and the UE 120 may receive, one or more SSBs and random access configuration information. In some examples, the random access configuration information may be transmitted in and/or indicated by system information (for example, in one or more system information blocks (SIBs)) and/or an SSB, such as for contention-based random access. Additionally or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR) responsive to the RAM (for example, a PRACH configuration index that corresponds to a specific PRACH period, frequency and time resources associated with one or more ROs, a number of SSBs per RO and contention-based preambles per SSB, and/or a duration for an RAR response window, and/or among other examples).

In a second operation 610, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identity (RAPID).

In a third operation 615, the network node 110 may transmit an RAR as a reply to the preamble. The message that includes the RAR may be referred to as message 2, msg2, MSG2, or a second message in a four-step random access procedure. In some examples, the RAR may indicate the detected RAPID (for example, received from the UE 120 in msg1). Additionally or alternatively, the RAR may indicate a resource allocation to be used by the UE 120 to transmit message 3 (msg3).

In some examples, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

In a fourth operation 620, the UE 120 may transmit an RRC connection request message. The RRC connection request message may be referred to as message 3, msg3, MSG3, or a third message of a four-step random access procedure. In some examples, the RRC connection request may include a UE identifier, UCI, and/or a PUSCH communication (for example, an RRC connection request).

In a fifth operation 625, the network node 110 may transmit an RRC connection setup message. The RRC connection setup message may be referred to as message 4, msg4, MSG4, or a fourth message of a four-step random access procedure. In some examples, the RRC connection setup message may include the detected UE identifier, a timing advance value, and/or contention resolution information. In a sixth operation 630, if the UE 120 successfully receives the RRC connection setup message, the UE 120 may transmit a HARQ ACK.

As indicated above, FIG. 6 is provided as an example. Other examples may differ from what is described with regard to FIG. 6.

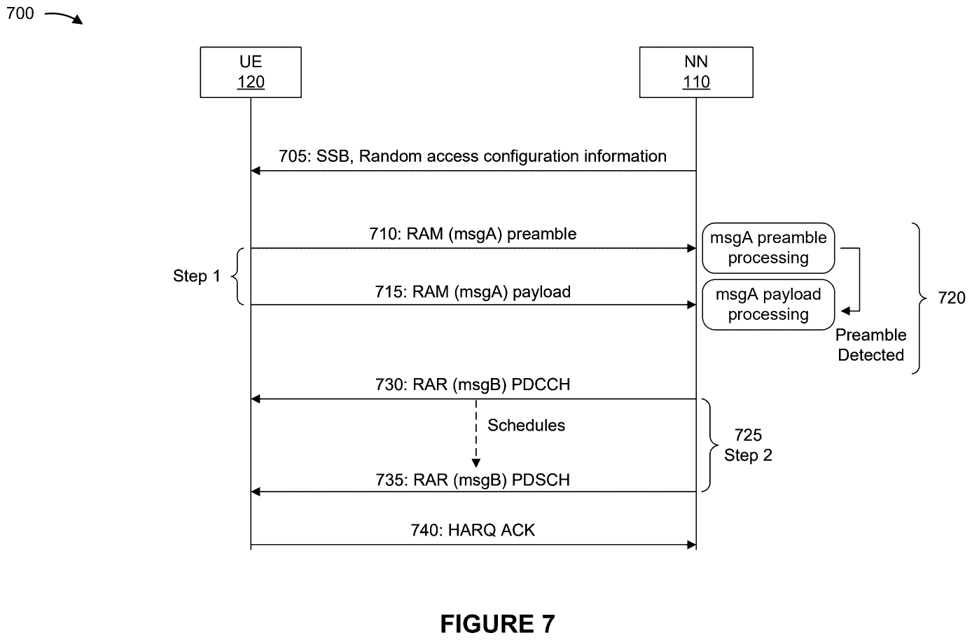

FIG. 7 is a diagram illustrating an example 700 of a two-step random access procedure in accordance with the present disclosure. As shown in FIG. 7, a network node 110 and a UE 120 may communicate with one another to perform the two-step random access procedure.

In a first operation 705, the network node 110 may transmit, and the UE 120 may receive, one or more SSBs and random access configuration information. In some examples, the random access configuration information may be transmitted in and/or indicated by system information (for example, in one or more SIBs) and/or an SSB, such as for contention-based random access. Additionally or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a RAM and/or receiving an RAR responsive to the RAM (for example, a PRACH configuration index that corresponds to a specific PRACH period, frequency and time resources associated with one or more ROs, a number of SSBs per RO and contention-based preambles per SSB, and/or a duration for an RAR response window, and/or among other examples).

In a second operation 710, the UE 120 may transmit, and the network node 110 may receive, a RAM preamble. In a third operation 715, the UE 120 may transmit, and the network node 110 may receive, a RAM payload. As shown, the UE 120 may transmit the RAM preamble and the RAM payload to the network node 110 as part of an initial (or first) step of the two-step random access procedure. In some examples, the RAM may be referred to as message A, msgA, a first message, or an initial message in a two-step random access procedure. Furthermore, in some examples, the RAM preamble may be referred to as a message A preamble, a msgA preamble, a preamble, or a PRACH preamble, and the RAM payload may be referred to as a message A payload, a msgA payload, or a payload. In some examples, the RAM may include some or all of the contents of message 1 (msg1) and message 3 (msg3) of a four-step random access procedure, which is described in more detail below. For example, the RAM preamble may include some or all contents of message 1 (for example, a PRACH preamble), and the RAM payload may include some or all contents of message 3 (for example, a UE identifier, UCI, and/or a PUSCH transmission).

In a fourth operation 720, the network node 110 may receive the RAM preamble transmitted by the UE 120. If the network node 110 successfully receives and decodes the RAM preamble, the network node 110 may then receive and decode the RAM payload.

In a fifth operation 725, the network node 110 may transmit an RAR (sometimes referred to as an RAR message). As shown, the network node 110 may transmit the RAR message as part of a second step of the two-step random access procedure. In some examples, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected RAPID, the detected UE identifier, a timing advance value, and/or contention resolution information.

In a sixth operation 730, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (for example, in DCI) for the PDSCH communication.

In a seventh operation 735, as part of the second step of the two-step random access procedure, the network node 110 may transmit the PDSCH communication for the RAR, as scheduled by the PDCCH communication. The RAR may be included in a MAC PDU of the PDSCH communication. In an eighth operation 740, if the UE 120 successfully receives the RAR, the UE 120 may transmit a HARQ ACK.

As indicated above, FIG. 7 is provided as an example. Other examples may differ from what is described with regard to FIG. 7.

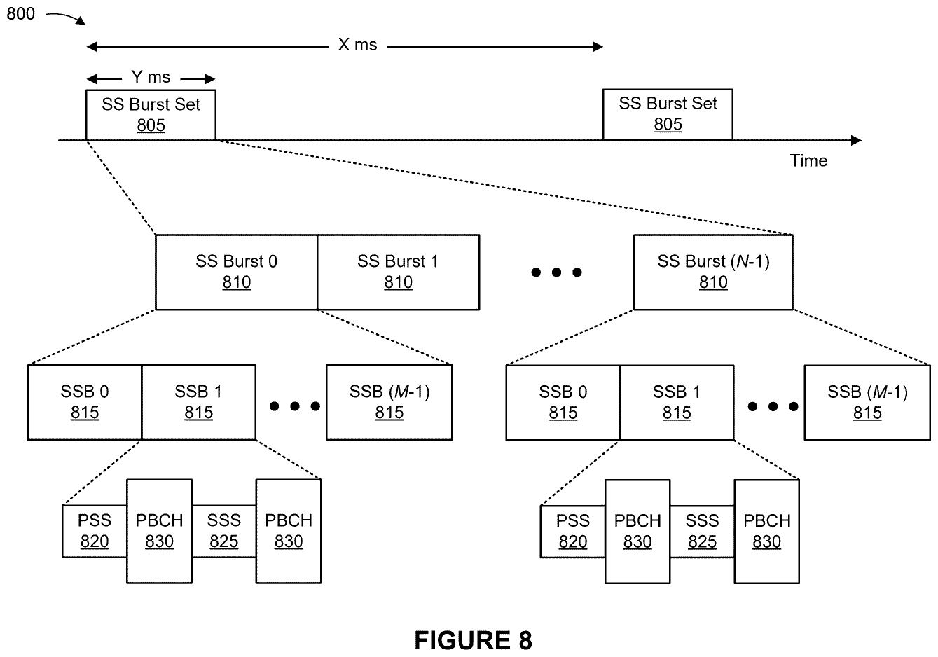

FIG. 8 is a diagram illustrating an example 800 of a synchronization signal (SS) hierarchy in accordance with the present disclosure. As shown in FIG. 8, the SS hierarchy may include an SS burst set 805, which may include multiple SS bursts 810, shown as SS burst 0 through SS burst N−1, where N is a maximum number of repetitions of the SS burst 810 that may be transmitted by one or more network nodes. As further shown, each SS burst 810 may include one or more SSBs 815, shown as SSB 0 through SSB M−1, where M is a maximum number of SSBs 815 that can be carried by an SS burst 810. In some examples, different SSBs 815 may be beam-formed differently (for example, transmitted using different beams), and may be used for cell search, cell acquisition, beam management, and/or beam selection (for example, as part of an initial network access procedure, such as a random access procedure). An SS burst set 805 may be periodically transmitted by a wireless node (for example, a network node 110), such as every X milliseconds (ms), as shown in FIG. 8. In some examples, an SS burst set 805 may have a fixed or dynamic length, shown as Y ms in FIG. 8. In some cases, an SS burst set 805 or an SS burst 810 may be referred to as a discovery reference signal (DRS) transmission window or an SSB measurement time configuration (SMTC) window.

In some examples, an SSB 815 may include resources that carry a PSS 820, an SSS 825, and/or PBCH 830. In some examples, multiple SSBs 815 are included in an SS burst 810 (for example, with transmission on different beams), and the PSS 820, the SSS 825, and/or the PBCH 830 may be the same across each SSB 815 of the SS burst 810. In some examples, a single SSB 815 may be included in an SS burst 810. In some examples, the SSB 815 may be at least four symbols (for example, OFDM symbols) in length, where each symbol carries one or more of the PSS 820 (for example, occupying one symbol), the SSS 825 (for example, occupying one symbol), and/or the PBCH 830 (for example, occupying two symbols). In some examples, an SSB 815 may be referred to as an SS/PBCH block.

In some examples, the symbols of an SSB 815 are consecutive, as shown in FIG. 8. In some examples, the symbols of an SSB 815 are non-consecutive. Similarly, in some examples, one or more SSBs 815 of the SS burst 810 may be transmitted in consecutive radio resources (for example, consecutive symbols) during one or more slots. Additionally or alternatively, one or more SSBs 815 of the SS burst 810 may be transmitted in non-consecutive radio resources.

In some examples, the SS bursts 810 may have a burst period, and the SSBs 815 of the SS burst 810 may be transmitted by a wireless node (for example, a network node 110) according to the burst period. In such examples, the SSBs 815 may be repeated during each SS burst 810. In some examples, the SS burst set 805 may have a burst set periodicity, whereby the SS bursts 810 of the SS burst set 805 are transmitted by the wireless node according to the fixed burst set periodicity. In other words, the SS bursts 810 may be repeated during each SS burst set 805.

In some examples, an SSB 815 may include an SSB index, which may correspond to a beam used to carry the SSB 815. A UE 120 may monitor for and/or measure SSBs 815 using different Rx beams during an initial network access procedure and/or a cell search procedure, among other examples. In accordance with the monitoring and/or measuring, the UE 120 may indicate one or more SSBs 815 with a best signal parameter (for example, an RSRP parameter) to a network node 110 (for example, directly or via one or more other network nodes). The network node 110 and the UE 120 may use the one or more indicated SSBs 815 to select one or more beams to be used for communication between the network node 110 and the UE 120 (for example, for a RACH procedure). Additionally or alternatively, the UE 120 may use the SSB 815 and/or the SSB index to determine a cell timing for a cell via which the SSB 815 is received (for example, a serving cell).

As indicated above, FIG. 8 is provided as an example. Other examples may differ from what is described with regard to FIG. 8.

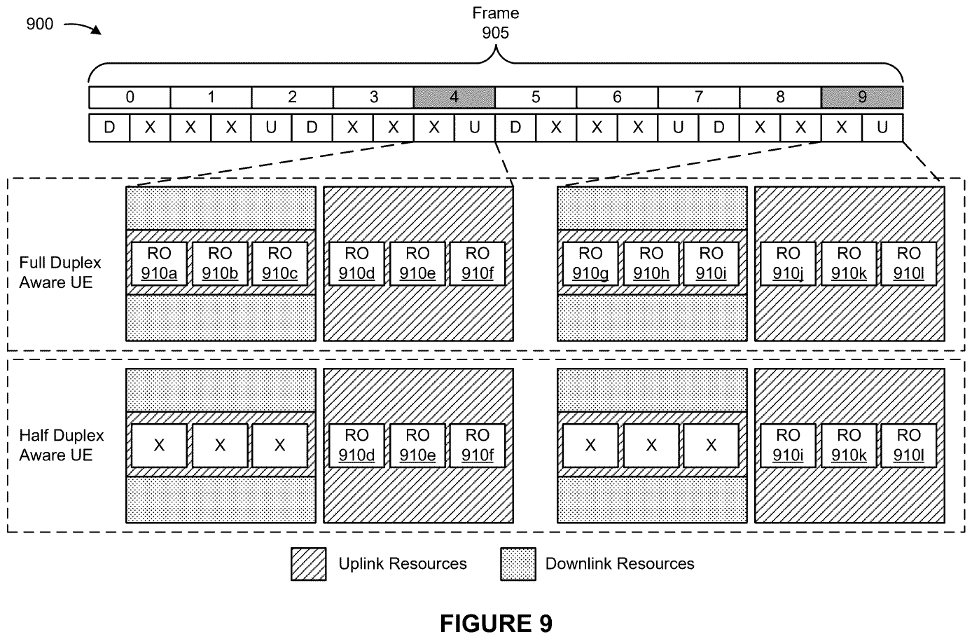

FIG. 9 is a diagram illustrating an example 900 of a RACH configuration using a shared PRACH configuration index for half duplex and full duplex operations in accordance with the present disclosure. In some examples, the RACH configuration shown in FIG. 9 may implement or be implemented by one or more techniques of FIGS. 1 through 8. For example, in accordance with the example 900, the network node 110 may transmit, and the UE 120 may receive, a single RACH configuration that configures the UE 120 with a set of ROs 910 for the UE 120 to perform a RACH procedure in accordance with half duplex operations or full duplex operations.

In some examples, the network node 110 may transmit, to the UE 120, control signaling (such as RRC signaling, MAC signaling, or DCI signaling), that is indicative of a set of PRACH parameters associated with the PRACH configuration. For example, the control signaling may indicate a PRACH configuration index from a set of PRACH configuration indexes, where the PRACH configuration index indicates and/or is associated with the set of PRACH parameters. In some examples, the set of PRACH configuration indexes may be defined in a wireless communication standard. For example, FIG. 9 illustrates a PRACH configuration associated with a set of PRACH parameters in accordance with Table 1.

TABLE 1

| | | | | | | Number | Number | |
|---|---|---|---|---|---|---|---|---|
| | | | | | | of | of | |
| | | | | | | PRACH | ROs | |
| PRACH | | n_{SFN}mode | | | | slots | within | |
| Configuration | Preamble | x = y | | Subframe | Starting | within | PRACH | PRACH |
| Index | Format | x | y | Number | Symbol | subframe | slot | duration |
| 94 | A2 | 2 | 1 | 4.9 | 0 | 2 | 3 | 4 |

In accordance with Table 1, the PRACH configuration is associated with a PRACH configuration index of 94. For example, PRACH configuration index 94 may correspond to a set of PRACH parameters, such as a preamble format, frequency hopping pattern, subframe number, starting symbol, number of PRACH slots within a subframe, number of ROs within a PRACH slot, and/or duration of the PRACH. By using the PRACH configuration index, the network node 110 may assign PRACH configurations to UEs 120 without individually specifying each parameter, which may reduce signaling overhead.

The preamble format (A2 in the example of Table 1) may indicate the structure and length of the PRACH preamble. Different preamble formats are used in accordance with network conditions and coverage requirements. Format A2 may be used for situations associated with preambles with a duration less than a threshold, often suitable for network cells with smaller coverage areas and relatively low propagation delays. This format impacts the total PRACH duration and helps determine the amount of time the UE 120 has to complete an initial access procedure.

The frequency hopping pattern (such as nsENmode x=y) defines the frequency hopping pattern during the PRACH. For example, frequency hopping is a technique that may reduce interference and increase the robustness of the connection. In the example 900, the values x=2 and y=1 represent the specific frequency hopping settings used by the network node 110. In some examples, the configuration of the frequency hopping parameter depends on a frequency plan associated with the network node 110 and a desired interference management strategy.

The subframe number may indicate which subframes within a frame 905 are designated for PRACH transmissions. In example 900, the frame 905 includes a set of 10 subframes (such as subframe 0 through subframe 9) where subframe 4 and subframe 9 are designated for PRACH transmissions by the UE 120. The subframe number helps synchronize the UE 120 with the frame timing of the network node 110, ensuring that the UE 120 transmissions occur at expected intervals and reducing collisions with other uplink transmissions.

The starting symbol designates the first OFDM symbol within the subframe where the PRACH preamble transmission may begin. In accordance with Table 1, the starting symbol is 0, meaning the PRACH preamble starts at the beginning of the designated subframe 4 and subframe 9. The starting symbol position helps control the timing of the PRACH transmission, which may reduce overlaps with other wireless communications.

The number of PRACH slots within a subframe indicates the number of PRACH slots available within the specified subframe. In accordance with Table 1, two slots are provided, giving UEs 120 more flexibility in timing for random access attempts within that subframe. As illustrated in FIG. 9, the first slot of subframe 4 and the first slot of subframe 9 may be an “X” slot which may refer to a full duplex slot (such as an SBFD slot or any other full duplex type slot as described in FIGS. 3 through 5B). In other words, the full duplex slots may include uplink resources and downlink resources. Additionally, as illustrated in FIG. 9, the second slot of subframe 4 and the second slot of subframe 9 may be a “U” slot, which may refer to an uplink slot (such as uplink interval 544 and/or uplink interval 558). Additionally, as illustrated in FIG. 9, one or more other subframes may include “D” slots which refer to downlink slots (such as downlink interval 542a and/or downlink interval 552). In other words, the uplink slots and downlink slots of FIG. 9 may be examples of half duplex slots.

The number of ROs 910 within the PRACH slot may be a parameter that indicates the number of ROs 910 configured for and/or included in each PRACH slot. In accordance with Table 1, each PRACH slot may include three ROs 910. Therefore, with three ROs 910 in each PRACH slot, the network node 110 provides multiple opportunities within each PRACH slot for the UE 120 to transmit a PRACH preamble.

The PRACH duration may be a parameter that refers to the total length of the PRACH preamble in OFDM symbols. In accordance with Table 1, a duration of 4 symbols is specified, which aligns with the preamble format and subframe timing.

In accordance with the set of PRACH parameters defined in Table 1, the UE 120 may be configured to operate in accordance with RACH operations during subframe 4 and subframe 9 of the frame 905. For example, in accordance with subframe 4 and subframe 9 respectively including two PRACH slots with three respective ROs 910, the UE 120 may be aware of up to 12 ROs 910 during which the UE 120 may transmit the PRACH preamble (for example ROs 910a, 910b, 910c, 910d, 910c, 910f, 910g, 910h, 910i, 910j, 910k, and 910l).

In some examples, the ROs 910 during which the UE 120 may be capable of transmitting the PRACH preamble may be in accordance with a capability of the UE 120. For example, as illustrated in FIG. 9, the UE 120 may be a full duplex aware UE 120 or a half duplex (or full duplex unaware) UE 120. A full duplex aware UE 120 may be aware of a capability of the network node 110 to perform full duplex operations. During a half duplex slot (such as the second slot of subframe 4 and subframe 9), the UE 120 transmits the PRACH preamble and is aware that the network node 110 is not concurrently transmitting downlink messages to one or more other UEs. However, in a full duplex slot (such as the first slot of subframe 4 and subframe 9), the full duplex aware UE 120 may transmit a PRACH preamble and may be aware that the network node 110 may be transmitting downlink messages to one or more other UEs 120. In other words, the UE 120 may transmit a PRACH preamble during ROs 910 configured in uplink and full duplex slots. Therefore, the full duplex aware UE 120 may be aware of ROs 910a through 910l for transmission of the PRACH preamble.

A half duplex UE 120 may be a UE 120 that is not aware of a full duplex capability of the network node 110. In accordance with lacking awareness of the full duplex capability of the network node 110, the UE 120 may be unaware of available ROs 910 during full duplex slots. For example, a half duplex UE 120 may operate in a full duplex slot (such as the first slot of subframe 4 and subframe 9) as though the slot is a downlink-only slot (for example, without any uplink resources) based on or otherwise associated with the UE 120 not being aware that the network node 110 configured a portion of the full duplex slot with uplink resources. Accordingly, the half duplex UE 120 may be unaware of ROs 910 configured during full duplex slots and may wait for ROs 910 configured specifically in uplink-only half duplex slots to transmit the PRACH preamble. Therefore, the half duplex UE 120 may be aware of ROs 910d through 910f and ROs 910j through 910l and may not be aware of ROs 910a through 910c or ROs 910g through 910i.

In accordance with the techniques of example 900, the full duplex aware UEs 120 and half duplex UEs 120 may receive a same PRACH configuration that include a first set of ROs 910 associated with half duplex operations (for example, ROs 910d through 910f and 910j through 910l) and a second set of ROs 910 associated with full duplex operations (for example, ROs 910a through 910c and 910g through 910i). Therefore, full duplex aware UEs 120 may transmit the PRACH preamble during an RO 910 in the first set of ROs 910 or the second set of ROs 910 in accordance with being full duplex aware, and the half duplex UEs 120 may transmit the PRACH preamble during an RO 910 in the first set of ROs 910 but not the second set of ROs 910.

In accordance with an RRC-connected UE 120, the network node 110 and/or the UE 120 may support one or more type of PRACH configurations. For instance, the example 900 illustrates the network node 110 and the UE 120 supporting a single shared PRACH configuration that includes the first set ROs 910 associated with half duplex operations and the second set of ROs 910 for full duplex operations. In some other examples, the network node 110 and/or the UE 120 may support multiple PRACH configurations, where a first PRACH configuration includes the first set of ROs 910 associated with half duplex operations and a second PRACH configuration includes the second set of ROs 910 for full duplex operations.

For both a single shared PRACH configuration and for multiple PRACH configurations, the first set of ROs 910 associated with half duplex operations may be referred to as legacy ROs 910. In some examples, legacy ROs 910 may be any ROs 910 included in uplink slots (such as the uplink interval 544), a half duplex flexible slot (such as a flexible slot that may be configured as the downlink interval 552 or the uplink interval 558), or a full duplex flexible slot (such as the flexible interval 542c that is configured to include sub-bands 554b and uplink sub-band 556b). In other words, legacy ROs 910 are valid for the half duplex UEs 120 (which may be referred to as legacy UEs 120). The second set of ROs 910 associated with full duplex operations may be referred to as additional ROs 910 (or SBFD-ROs 910). In accordance with the single PRACH configuration, the additional ROs 910 (or SBFD-ROs 910) may be valid ROs 910 included in full duplex slots (such as downlink interval 542b, which is configured as an SBFD-DL interval that includes sub-bands 554a and the uplink sub-band 556a). In accordance with the multiple PRACH configurations, the additional ROs 910 (or SBFD ROs 910) may be valid ROs 910 indicated in the second PRACH configuration.

For a random access operation for a full duplex aware UE 120 in the RRC connected state, and in accordance with the single RACH configuration, the ROs 910 within an uplink sub-band in SBFD symbols may be a valid RO 910. For a random access operation for a full duplex aware UE 120 in the RRC connected state, and in accordance with the multiple RACH configurations, ROs 910 within the uplink sub-band in SBFD symbols configured by the second RACH configuration may be valid ROs 910. In some examples, the network node 110 may refrain from (may not support) enabling, for the UE 120, the single RACH configuration and the multiple RACH configurations at the same time. In some examples, the UE 120 may not support both the single RACH configuration and the multiple RACH configurations.

By operating in accordance with the single RACH configuration, the network node 110 and the UE 120 may reduce signaling overhead compared to the multiple RACH configurations. Additionally, half duplex UEs 120 may perform random access operations in full duplex symbols, if the ROs 910 are configured in full duplex flexible slots. By operating in accordance with the multiple RACH configurations, the network node 110 may use different parameters for the first RACH configuration and the second RACH confirmation, which may allow for more flexibility in configuring ROs 910 during half duplex slots and full duplex slots. For instance, the different parameters may include one or more of different RACH preambles, different RO time and/or frequency resources, or different power configuration parameters.

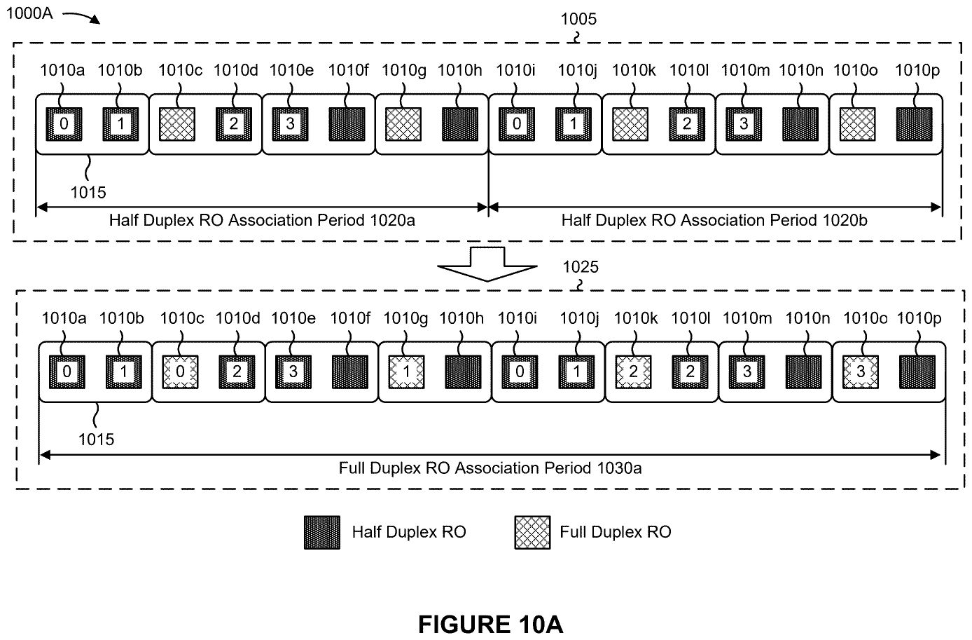

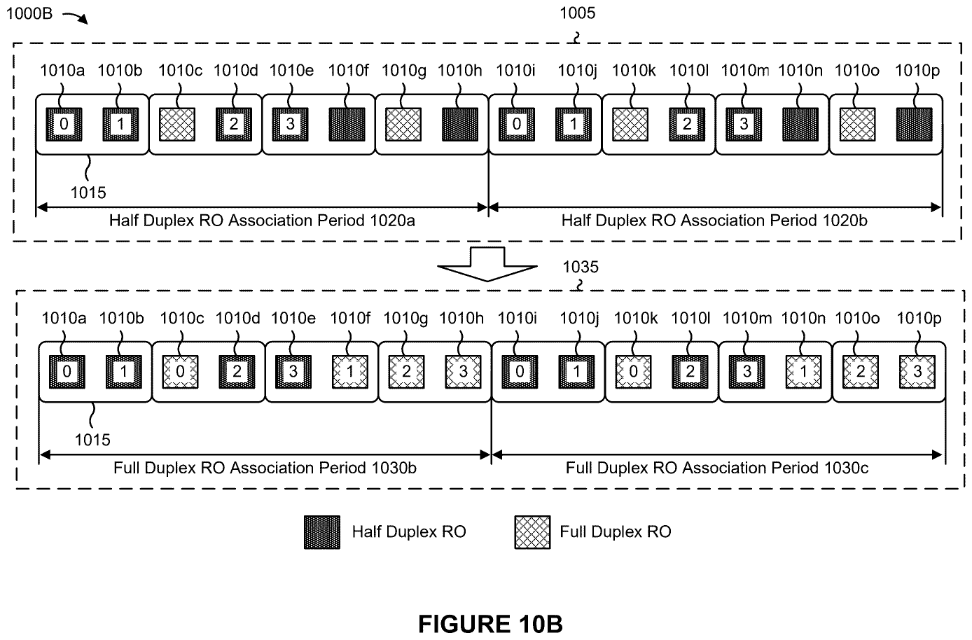

FIG. 10A is a diagram illustrating an example 1000A of an SSB to RO mapping without reallocating unmapped ROs for full duplex operations in accordance with the present disclosure. In some examples, example 1000A may implement or be implemented by one or more of FIGS. 1 through 9. For instance, example 1000A may illustrate mapping a set of SSBs (such as SSBs 815) associated with respective SSB indexes to a set of ROs 1010 (such as the ROs 910). Additionally, as illustrated in example 1000A, the ROs 1010 may include a first set of ROs 1010 associated with half duplex operations and a second set of ROs 1010 associated with full duplex operations, as described with reference to FIG. 9. For example, an RO 1010a, an RO 1010b, an RO 1010d, an RO 1010e, an RO 1010f, an RO 1010h, an RO 1010i, an RO 1010j, an RO 10101, an RO 1010m, an RO 1010n, and an RO 1010p may be half duplex ROs, and an RO 1010c, an RO 1010g, an RO 1010k, and an RO 10100 may be full duplex ROs. Additionally, the set of ROs 1010 may be configured in accordance with a single RACH configuration, as described with reference to FIG. 9.

In accordance with example 1000A, the UE 120 may perform a first SSB to RO mapping 1005. In some examples, the first SSB to RO mapping 1005 may be associated with mapping a set of SSB indexes to the set of half duplex ROs. In example 1000A, the set of SSB indexes may include 4 indexes associated with 4 SSBs (such as SSB0, SSB1, SSB2, and SSB3). In some examples, the network node 110 may indicate the set of SSB indexes in the single RACH configuration. Additionally, the UE 120 may map the SSB indexes to the half duplex ROs over one or more half duplex RO association periods 1020. In some examples, a given half duplex RO association period 1020 may be the smallest integer of {1, 2, 4, 8, 16} PRACH configuration periods 1015 such that each SSB index of the set of SSB indexes is mapped at least once to a respective half duplex RO. For instance, in example 1000A, during a first PRACH configuration period 1015, the UE 120 maps SSB0 to the RO 1010a and maps SSB1 to the RO 1010b. In a second PRACH configuration period 1015, the UE 120 maps SSB2 to the RO 1010d. In a third PRACH configuration period 1015, the UE 120 maps SSB3 to the RO 1010c. Therefore, after 3 PRACH configuration periods 1015, the UE 120 has mapped each SSB index of the set of SSB indexes to a respective half duplex RO. However, because mapping each SSB index spanned three PRACH configuration periods 1015, the half duplex RO association period 1020a may be four PRACH configuration periods in accordance with satisfying the smallest integer of {1, 2, 4, 8, 16} PRACH configuration periods 1015. In some examples, mapping SSBs to the ROs during a single PRACH configuration period 1015 may be referred to as an RO mapping cycle. That is, the UE 120 may map SSBs to the half duplex ROs during 3 RO mapping cycles in accordance with the RO association period 1020a.

In other words, the half duplex RO association period 1020a for mapping SSB indexes (or SS/PBCH block indexes) to the ROs is the smallest value in a set of configured values (such as {1, 2, 4, 8, 16}) such that

$${N}_{T x}^{S S B} SSB$$

indexes are mapped at least once to the half duplex ROs within the half duplex RO association period 1020a. In some examples, the UE 120 may obtain the value of

$${N}_{T x}^{S S B}$$

from a value included in a SIB type 1 (SIB1) received from the network node 110 (such as ssb-PostionsInBurst) or in a field of an RRC configuration message received from the network node 110 (such as ServingCellConfigCommon).

If, however, after an integer number of the RO mapping cycles in the half duplex RO association period 1020a, there is a set of ROs (or PRACH preambles) that are not mapped to the

$${N}_{T x}^{S S B} SSB$$

indexes, no SSB indexes are mapped to the set of ROs (or PRACH preambles). For instance, in example 1000A, after each of SSB0, SSB1, SSB2, and SSB3 are respectively mapped to the RO 1010a, the RO 1010b, the RO 1010d, and the RO 1010c, the half duplex RO association period 1020a may include additional half duplex ROs that are not mapped (such as the RO 1010f and the RO 1010h).

As illustrated in example 1000A, there may be a half duplex RO association period 1020b that is after the half duplex RO association period 1020a. In accordance with the techniques of the first SSB to RO mapping 1005, the UE 120 may map the set of SSB indexes to the half duplex ROs included in the half duplex RO association period 1020b. For example, SSB0 may be mapped to the RO 1010i, SSB I may be mapped to the RO 1010j, SSB2 may be mapped to the RO 10101, and SSB3 may be mapped to the RO 1010m. However, the RO 1010n and the RO 1010p may remain unmapped in accordance with not being mapped to the

$${N}_{T x}^{S S B} SSB$$

indexes. Therefore, in accordance with the techniques of the first SSB to RO mapping 1005, the RO 1010f, the RO 1010h, the RO 1010n, and the RO 1010p may remain unmapped.

In some examples, concurrent with or after the first SSB to RO mapping 1005, the UE 120 may perform a second SSB to RO mapping 1025 (for example, if the UE 120 is SBFD-aware or full duplex aware). For example, the second SSB to RO mapping 1025 may be associated with mapping the set of SSB indexes (SSB0, SSB1, SSB2, and SSB3) to the set of full duplex ROs. In other words, the UE 120 may map the same set of SSB indexes to the full duplex ROs that the UE 120 maps the half duplex ROs to.

Additionally, the UE 120 may map the set of SSB indexes to the full duplex ROs over one or more full duplex RO association periods 1030. In some examples, a given full duplex RO association period 1030 may be the smallest integer of {1, 2, 4, 8, 16} PRACH configuration periods 1015 such that each SSB index of the set of SSB indexes is mapped at least once to a respective full duplex RO. For instance, in example 1000A, during multiple PRACH configuration periods, the UE 120 maps SSB0 to the RO 1010c, maps SSB1 to the RO 1010g, maps SSB2 to the RO 1010k, and maps SSB3 to the RO 10100. After 8 PRACH configuration periods 1015, the UE 120 may map each SSB index of the set of SSB indexes to a respective full duplex RO. Therefore, the full duplex RO association period 1030a may include 8 PRACH configuration periods 1015 in accordance with satisfying the smallest integer of {1, 2, 4, 8, 16} PRACH configuration periods 1015.

However, as described herein, one or more the ROs may remain unmapped after performing the first SSB to RO mapping 1005 and the second SSB to RO mapping 1025. For instance, the RO 1010f, the RO 1010h, the RO 1010n, and the RO 1010p may remain unmapped, despite being valid ROs that the UE 120 may use for transmission of a PRACH preamble. Therefore, the frequency and time resources associated with the unmapped ROs may go unused by the UE 120, which may decrease resource efficiency between the UE 120 and network node 110. Additionally, by not using the unmapped ROs, a duration between the UE 120 transmitting repetitions of the PRACH preamble during different ROs may increase, which may increase latency associated with performing the RACH procedure.

Various aspects relate generally to reallocating unmapped half duplex ROs for use in full duplex operations. For example, as described with reference to FIG. 9, one or more ROs may be scheduled during full duplex flexible slots but may be configured as half duplex ROs such that half duplex capable UE 120s (legacy UE 120s) may still transmit PRACH preambles during those one or more the ROs. Therefore, the UE 120 may identify one or more half duplex ROs that remain unmapped after performing the first SSB to RO mapping 1005, and reallocate the one or more half duplex ROs to be full duplex ROs. In other words, the UE 120 may move the unmapped half duplex ROs to the set of full duplex ROs. Further description of reallocating unmapped ROs for full duplex operations is provided herein, including with reference to FIG. 10B.

FIG. 10B is a diagram illustrating an example 1000B associated with reallocating unmapped ROs for full duplex operation in accordance with the present disclosure. In some aspects, the example 1000B may implement or be implemented by one or more of FIGS. 1 through 9. Additionally, the example 1000B may include one more aspects of example 1000A. For example, example 1000B may include the first SSB to RO mapping 1005, as described with reference to example 1000A.

Additionally, example 1000B may include one or more aspects that are different than example 1000A. For instance, example 1000B may include a third SSB to RO mapping 1035, which the UE 120 may perform alternatively to the second SSB to RO mapping 1025.

In some examples, the UE 120 may perform the third SSB to RO mapping 1035 after completing the first SSB to RO mapping 1005. For example, as part of the third SSB to RO mapping 1035, the UE 120 may determine which of the half duplex ROs remain unmapped after performing the first SSB to RO mapping 1005 (such as the RO 1010f, the RO 1010h, the RO 1010n, and the RO 1010p). Accordingly, the UE 120 may determine which of the unmapped half duplex ROs may be reallocated as full duplex ROs.

In some examples, the UE 120 may determine which unmapped half duplex ROs to reallocate in accordance with the type of slots associated with the unmapped half duplex ROs. For example, as described with reference to FIG. 9, a given unmapped half duplex RO may be associated with a half duplex uplink slot, a half duplex flexible slot, or a full duplex flexible slot (such as a flexible SBFD slot). In some examples, the UE 120 may reallocate an unmapped half duplex slot associated with any of a half duplex uplink slot, a half duplex flexible slot, or a full duplex flexible slot. In some examples, the UE 120 may reallocate unmapped half duplex ROs associated with a half duplex uplink slot, unmapped half duplex ROs associated with a half duplex flexible slot, or unmapped half duplex ROs associated with a full duplex flexible slot, or a combination thereof.

In the example 1000B, the UE 120 may determine that the RO 1010f, the RO 1010h, the RO 1010n, and the RO 1010p are each eligible to be reallocated as full duplex ROs. Therefore, the UE 120 may update the full duplex ROs to include the RO 1010c, the RO 1010f, the RO 1010g, the RO 1010h, the RO 1010k, the RO 1010n, the RO 1010o, and the RO 1010p.

In accordance with reallocating the unmapped half duplex ROs, the UE 120 may map the set of SSB indexes to the updated set of full duplex ROs over one or more full duplex RO association periods 1030. In some examples, a given full duplex RO association period 1030 may be the smallest integer of {1, 2, 4, 8, 16} PRACH configuration periods 1015 such that each SSB index of the set of SSB indexes is mapped at least once to a respective full duplex RO. For instance, in example 1000B, during multiple PRACH configuration periods 1015, the UE 120 maps SSB0 to the RO 1010c, maps SSB1 to the RO 1010f, maps SSB2 to the RO 1010g, and maps SSB3 to the RO 1010h. After 4 PRACH configuration periods 1015, the UE 120 may map each SSB index of the set of SSB indexes to a respective full duplex RO. Therefore, a full duplex RO association period 1030b may be 4 PRACH configuration periods in accordance with satisfying the smallest integer of {1, 2, 4, 8, 16} PRACH configuration periods 1015.

As illustrated in the example 1000B, after the full duplex RO association period 1030b, there may be a full duplex RO association period 1030c. In accordance with the techniques of the third SSB to RO mapping 1035, the UE 120 may map the set of SSB indexes to the full duplex ROs of the full duplex RO association period 1030c. For example, SSB0 may be mapped to the RO 1010k, SSB1 may be mapped to the RO 1010n, SSB2 may be mapped to the RO 1010o, and SSB3 may be mapped to the RO 1010p.

Particular aspects of the third SSB to RO mapping 1035 described in this disclosure can be implemented to realize one or more of the following potential advantages. For example, by reallocating unmapped half duplex ROs to the set of full duplex ROs, the UE 120 may map SSBs to ROs that may otherwise remain unmapped, which may reduce the number of unused ROs. Additionally, by reallocating unmapped half duplex ROs, the number of full duplex ROs per PRACH configuration period 1015 may increase, which may decrease the number of PRACH configuration period 1015 per full duplex RO association period 1030. For instance, the full duplex RO association period 1030b and the full duplex RO association period 1030c may each be half the duration of the full duplex RO association period 1030a. By reducing the durations of the full duplex RO association periods 1030, the UE 120 may reduce the latency associated with transmitting a PRACH preamble during the full duplex ROs. Additionally, the described techniques may decrease the time between each RO that is mapped to an SSB, which may increase a number of PRACH preamble transmissions the UE 120 may perform over a given duration. Therefore, the UE 120 and network node 110 may reduce latency associated with performing the RACH procedure.

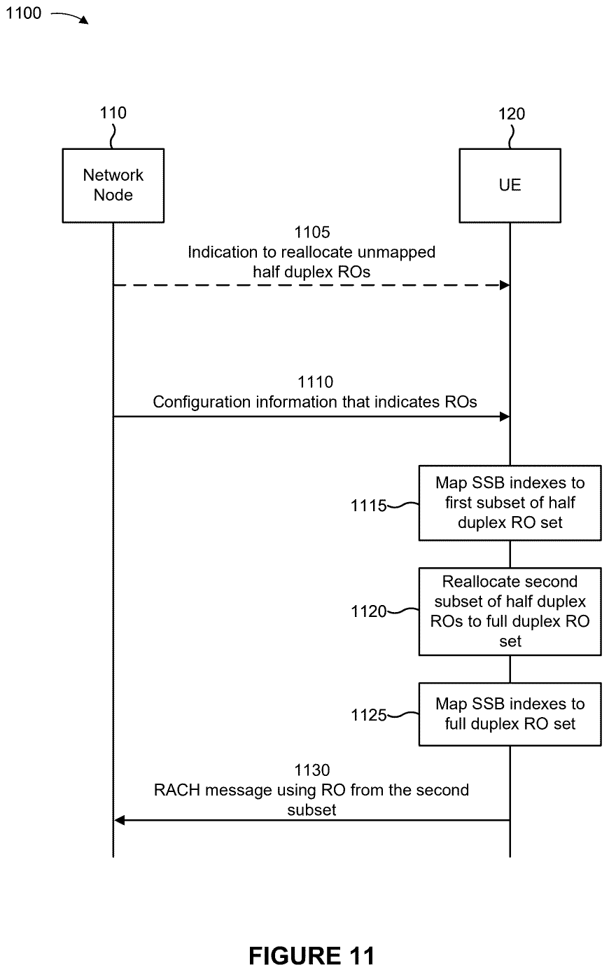

In some examples, the UE 120 may determine whether to operate in accordance with the third SSB to RO mapping 1035. For example, the UE may determine whether to reallocate unmapped half duplex ROs to the set of full duplex ROs in accordance with signaling from the network node 110 and/or according to one or more PRACH configuration parameters. Further description of the UE determining whether to reallocate unmapped half duplex ROs is provided herein, including with reference to FIG. 11.

FIG. 11 is a diagram illustrating an example 1100 associated with reallocating unmapped ROs for full duplex operation in accordance with the present disclosure. Example 1100 may implement or be implemented by one or more aspects of FIGS. 1 through 10B. For instance, example 1100 includes wireless communications between the UE 120 and the network node 110. Alternative examples of the following may be implemented, where some operations are performed in a different order than described, or not described at all. In some cases, one or more operations may include additional features not mentioned below, or further operations may be added. In addition, while example 1100 shows operations between the UE 120 and the network node 110, the communication may occur between any number of network devices of various types described herein.

In a first operation 1105, the network node 110 may transmit, and the UE 120 may receive, signaling that is associated with whether the UE 120 should reallocate half duplex ROs that are not mapped to a set of SSB indexes.

In some examples, the signaling may include an explicit indication of whether to reallocate ROs that are not mapped to the set of SSB indexes in accordance with half duplex operations to a second set of ROs associated with full duplex operations. For example, a first value of the indication may indicate for the UE 120 to reallocate unmapped ROs, and a second value of the indication may indicate for the UE 120 to not reallocate unmapped ROs. In some examples, the signaling may be semi-static signaling. For example, the indication to reallocate unmapped ROs may be included in a SIBI or in an RRC configuration message.

In some examples, the signaling may indicate a threshold associated with a PRACH configuration periodicity. Alternatively, the threshold may be defined in a wireless communication standard. Therefore, the UE 120 may compare a configured PRACH configuration periodicity with the threshold to determine whether to reallocate unmapped ROs. In some examples, the signaling of the first operation 1105 may be optional.

In a second operation 1110, the network node 110 may transmit, and the UE 120 may receive, configuration information. For example, the configuration information may indicate a first set of ROs associated with half duplex operations (such as half duplex ROs, with reference to FIGS. 10A and 10B) and a set of SSB indexes (such as SSB0, SSB1, SSB2, and SSB3, with reference to FIGS. 10A and 10B). In some aspects, the configuration information may be include a single PRACH configuration, for example, as described with reference to FIG. 9. For example, the configuration information may indicate the first set of ROs and may additionally indicate a second set of ROs associated with full duplex operations (such as full duplex ROs, with reference to FIGS. 10A and 10B). In some examples, the configuration information may indicate an RO periodicity (such as PRACH configuration periodicity associated with the PRACH configuration periods 1015, as described with reference to FIGS. 10A and 10B). In some examples, one or more aspects of the signaling of the first operation 1105 may be included in the configuration information. In some other aspects, the set of SSB indexes may be configured in SIB1 or via RRC (for example, ServingCellConfigCommon).

In a third operation 1115, the UE 120 may map the set of SSB indexes to a first subset of ROs of the first set of ROs in accordance with the half duplex operations. In some examples, the third operation 1115 may correspond to and/or may be associated with the first SSB to RO mapping 1005, as described with reference to FIGS. 10A and 10B. For example, the UE 120 may map, during an integer number of RO mapping cycles, the set of SSB indexes to the first subset of ROs of the first set of ROs. In accordance with performing the third operation 1115, there may be a second subset of ROs of the first set of ROs that are not mapped to the set of SSB indexes during the integer number of RO mapping cycles (such as RO 1010f, RO 1010h, RO 1010n, and RO 1010p, as described with refence to FIGS. 10A and 10B).

In a fourth operation 1120, the UE 120 may reallocate one or more ROs of the second subset of ROs from the first set of ROs to a second set of ROs associated with full duplex operations. In some examples, the one or more ROs of the second subset of ROs may include ROs associated with an uplink slot, a flexible half duplex slot, or a flexible full duplex slot. In some examples, the one or more ROs of the second subset of ROs may include ROs associated with a flexible full duplex slot (such as a flexible SBFD slot). In some examples, the fourth operation 1120 may correspond to and/or be associated with the third SSB to RO mapping 1035, as described with reference to FIG. 10B.

In some examples, the UE 120 may determine whether to perform the fourth operation 1120 in accordance with information indicated in the first operation 1105 and/or information indicated in the second operation 1110. For example, if the UE 120 receives the semi-static signaling indicating for the UE 120 to reallocate half duplex ROs, then the UE 120 may perform the fourth operation 1120. Additionally or alternatively, if the PRACH configuration periodicity satisfies the threshold (for example, the PRACH configuration periodicity exceeds a threshold), then the UE 120 may reallocate unmapped half duplex ROs.

In a fifth operation 1125, the UE 120 may map, after reallocating the one or more ROs to the second set of ROs associated with full duplex operations, the set of SSB indexes to the second set of ROs. In some examples, the fifth operation 1125 may correspond to and/or may be associated with the third SSB to RO mapping 1035, as described with reference to FIG. 10B.

In a sixth operation 1130, the UE 120 may transmit, and the network node 110 may receive during an RO, a RACH message in accordance with full duplex operations. In some examples, the RO may be an RO that the UE 120 reallocated to the second set of ROs in accordance with the at least one RO not being included in the first subset of ROs mapped to the set of SSB indexes. In some other examples, the RO may be an RO from the second set of ROs before the unmapped ROs from the first set of ROs were reallocated to the second set of ROs. In some examples, the RACH message may be an example of a PRACH preamble (for example, msg1 or msgA preamble). In some examples, transmission of the RACH message in accordance with full duplex operations is in accordance with the UE 120 being a full duplex aware UE 120.

In accordance with the RACH message, the UE 120 and network node 110 may perform a RACH procedure. In some examples, the RACH procedure may be a four step random access procedure, as described with reference to FIG. 6. In some examples, the RACH procedure may be a two step random access procedure, as described with reference to FIG. 7.

FIG. 12 is a flowchart illustrating an example process 1200 performed, for example, at a UE or an apparatus of a UE that supports reallocation of ROs for full duplex operations in accordance with the present disclosure. Example process 1200 is an example where the apparatus or the UE (for example, UE 120) performs operations associated with reallocation of random access channel occasions for full duplex operations.

As shown in FIG. 12, in some aspects, process 1200 may include receiving, from a network node, configuration information that indicates a first set of ROs associated with half duplex operations and a set of SSB indexes (block 1210). For example, the UE (such as by using communication manager 150 or reception component 1302, depicted in FIG. 13) may receive, from a network node, configuration information that indicates a first set of ROs associated with half duplex operations and a set of SSB indexes, as described above.

As further shown in FIG. 12, in some aspects, process 1200 may include mapping the set of SSB indexes to a first subset of ROs of the first set of ROs in accordance with the half duplex operations (block 1220). For example, the UE (such as by using communication manager 150 or mapping component 1310, depicted in FIG. 13) may map the set of SSB indexes to a first subset of ROs of the first set of ROs in accordance with the half duplex operations, as described above.

As further shown in FIG. 12, in some aspects, process 1200 may include transmitting, during at least one RO of the first set of ROs, a RACH message in accordance with full duplex operations in accordance with the at least one RO not being included in the first subset of ROs mapped to the set of SSB indexes (block 1230). For example, the UE (such as by using communication manager 150 or transmission component 1304, depicted in FIG. 13) may transmit, during at least one RO of the first set of ROs, a RACH message in accordance with full duplex operations in accordance with the at least one RO not being included in the first subset of ROs mapped to the set of SSB indexes, as described above.

Process 1200 may include additional aspects, such as any single aspect or any combination of aspects described below or in connection with one or more other processes described elsewhere herein.

In a first additional aspect, mapping the set of SSB indexes to the first subset of ROs comprises mapping, during an integer number of mapping cycles, the set of SSB indexes to the first subset of ROs of the first set of ROs, wherein the first set of ROs includes a second subset of ROs that is not mapped to the set of SSB indexes during the integer number of mapping cycles, and reallocating one or more ROs of the second subset of ROs from the first set of ROs to a second set of ROs associated with full duplex operations.

In a second additional aspect, alone or in combination with the first aspect, process 1200 includes mapping, after reallocating the one or more ROs to the second set of ROs associated with full duplex operations, the set of SSB indexes to a respective plurality of ROs of the second set of ROs, wherein the at least one RO is mapped to an SSB index of the set of SSB indexes in accordance with full duplex operations.

In a third additional aspect, alone or in combination with one or more of the first and second aspects, process 1200 includes receiving, from the network node, signaling that includes an indication to reallocate ROs that are not mapped to the set of SSB indexes in accordance with half duplex operations to a second set of ROs associated with full duplex operations, wherein transmitting the RACH message during the at least one RO is in accordance with the indication.

In a fourth additional aspect, alone or in combination with one or more of the first through third aspects, transmitting the RACH message during the at least one RO is in accordance with an RO periodicity indicated in the configuration information satisfying a threshold.

In a fifth additional aspect, alone or in combination with one or more of the first through fourth aspects, the threshold is defined in a wireless communication standard.

In a sixth additional aspect, alone or in combination with one or more of the first through fifth aspects, process 1200 includes receiving, from the network node, signaling that indicates the threshold.

In a seventh additional aspect, alone or in combination with one or more of the first through sixth aspects, process 1200 includes mapping the at least one RO to an SSB index of the set of SSB indexes for full duplex operations in accordance with the at least one RO being associated with an uplink slot, a flexible half duplex slot, or a flexible full duplex slot.

In an eighth additional aspect, alone or in combination with one or more of the first through seventh aspects, process 1200 includes mapping the at least one RO to an SSB index of the set of SSB indexes for full duplex operations in accordance with the at least one RO being associated with a flexible full duplex slot.

In a ninth additional aspect, alone or in combination with one or more of the first through eighth aspects, transmission of the RACH message in accordance with full duplex operations is in accordance with the UE being a full duplex aware UE.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication that supports reallocation of ROs for full duplex operations in accordance with the present disclosure. The apparatus 1300 may be a UE, or a UE may include the apparatus 1300. In some aspects, the apparatus 1300 includes a reception component 1302, a transmission component 1304, and a communication manager 1306, which may be in communication with one another (for example, via one or more buses). As shown, the apparatus 1300 may communicate with another apparatus 1308 (such as a UE 120, a network node 110, or another wireless communication device) using the reception component 1302 and the transmission component 1304. The communication manager 1306 may be included in, or implemented via, a processing system (for example, the processing system 140). In some aspects, the communication manager 1306 is the communication manager 150.

In some aspects, the apparatus 1300 may be configured to and/or operable to perform one or more operations described herein in connection with FIGS. 3-11. Additionally or alternatively, the apparatus 1300 may be configured to and/or operable to perform one or more processes described herein, such as process 1200 of FIG. 12.

The reception component 1302 may receive communications, such as reference signals, control information, and/or data communications, from the apparatus 1308. The reception component 1302 may provide received communications to one or more other components of the apparatus 1300, such as the communication manager 1306. In some aspects, the reception component 1302 may perform signal processing on the received communications, and may provide the processed signals to the one or more other components in a similar manner as described above in connection with FIG. 1. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, and/or data communications, to the apparatus 1308. In some aspects, the communication manager 1306 may generate communications and may transmit the generated communications to the transmission component 1304 for transmission to the apparatus 1308. In some aspects, the transmission component 1304 may perform signal processing on the generated communications, and may transmit the processed signals to the apparatus 1308 in a similar manner as described above in connection with FIG. 1. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE. In some aspects, the transmission component 1304 may be co-located with the reception component 1302.

The communication manager 1306 may receive or may cause the reception component 1302 to receive, from a network node, configuration information that indicates a first set of ROs associated with half duplex operations and a set of SSB indexes. The communication manager 1306 may map the set of SSB indexes to a first subset of ROs of the first set of ROs in accordance with the half duplex operations. The communication manager 1306 may transmit or may cause the transmission component 1304 to transmit, during at least one RO of the first set of ROs, a RACH message in accordance with full duplex operations in accordance with the at least one RO not being included in the first subset of ROs mapped to the set of SSB indexes. In some aspects, the communication manager 1306 may perform one or more operations described elsewhere herein as being performed by one or more components of the communication manager 1306.

In some aspects, the communication manager 1306 includes a set of components, such as a mapping component 1310. Alternatively, the set of components may be separate and distinct from the communication manager 1306. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1302 may receive, from a network node, configuration information that indicates a first set of ROs associated with half duplex operations and a set of SSB indexes. The mapping component 1310 may map the set of SSB indexes to a first subset of ROs of the first set of ROs in accordance with the half duplex operations. The transmission component 1304 may transmit, during at least one RO of the first set of ROs, a RACH message in accordance with full duplex operations in accordance with the at least one RO not being included in the first subset of ROs mapped to the set of SSB indexes.

The mapping component 1310 may map, after reallocating the one or more ROs to the second set of ROs associated with full duplex operations, the set of SSB indexes to a respective plurality of ROs of the second set of ROs, wherein the at least one RO is mapped to an SSB index of the set of SSB indexes in accordance with full duplex operations.

The reception component 1302 may receive, from the network node, signaling that includes an indication to reallocate ROs that are not mapped to the set of SSB indexes in accordance with half duplex operations to a second set of ROs associated with full duplex operations, wherein transmitting the RACH message during the at least one RO is in accordance with the indication.

The reception component 1302 may receive, from the network node, signaling that indicates the threshold.

The mapping component 1310 may map the at least one RO to an SSB index of the set of SSB indexes for full duplex operations in accordance with the at least one RO being associated with an uplink slot, a flexible half duplex slot, or a flexible full duplex slot.

The mapping component 1310 may map the at least one RO to an SSB index of the set of SSB indexes for full duplex operations in accordance with the at least one RO being associated with a flexible full duplex slot.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a network node, configuration information that indicates a first set of random access channel (RACH) occasions (ROs) associated with half duplex operations and a set of synchronization signal block (SSB) indexes; mapping the set of SSB indexes to a first subset of ROs of the first set of ROs in accordance with the half duplex operations; and transmitting, during at least one RO of the first set of ROs, a RACH message in accordance with full duplex operations in accordance with the at least one RO not being included in the first subset of ROs mapped to the set of SSB indexes.

Aspect 2: The method of Aspect 1, wherein mapping the set of SSB indexes to the first subset of ROs comprises: mapping, during an integer number of mapping cycles, the set of SSB indexes to the first subset of ROs of the first set of ROs, wherein the first set of ROs includes a second subset of ROs that is not mapped to the set of SSB indexes during the integer number of mapping cycles; and reallocating one or more ROs of the second subset of ROs from the first set of ROs to a second set of ROs associated with full duplex operations.

Aspect 3: The method of Aspect 2, further comprising: mapping, after reallocating the one or more ROs to the second set of ROs associated with full duplex operations, the set of SSB indexes to a respective plurality of ROs of the second set of ROs, wherein the at least one RO is mapped to an SSB index of the set of SSB indexes in accordance with full duplex operations.

Aspect 4: The method of any of Aspects 1-3, further comprising: receiving, from the network node, signaling that includes an indication to reallocate ROs that are not mapped to the set of SSB indexes in accordance with half duplex operations to a second set of ROs associated with full duplex operations, wherein transmitting the RACH message during the at least one RO is in accordance with the indication.

Aspect 5: The method of any of Aspects 1-4, wherein transmitting the RACH message during the at least one RO is in accordance with an RO periodicity indicated in the configuration information satisfying a threshold.

Aspect 6: The method of Aspect 5, wherein the threshold is defined in a wireless communication standard.

Aspect 7: The method of Aspect 5, further comprising: receiving, from the network node, signaling that indicates the threshold.

Aspect 8: The method of any of Aspects 1-7, further comprising: mapping the at least one RO to an SSB index of the set of SSB indexes for full duplex operations in accordance with the at least one RO being associated with an uplink slot, a flexible half duplex slot, or a flexible full duplex slot.

Aspect 9: The method of any of Aspects 1-8, further comprising: mapping the at least one RO to an SSB index of the set of SSB indexes for full duplex operations in accordance with the at least one RO being associated with a flexible full duplex slot.

Aspect 10: The method of any of Aspects 1-9, wherein transmission of the RACH message in accordance with full duplex operations is in accordance with the UE being a full duplex aware UE.

Aspect 11: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-10.

Aspect 12: An apparatus for wireless communication at a device, the apparatus comprising one or more memories and one or more processors coupled to the one or more memories, the one or more processors configured to cause the device to perform the method of one or more of Aspects 1-10.

Aspect 13: An apparatus for wireless communication, the apparatus comprising at least one means for performing the method of one or more of Aspects 1-10.

Aspect 14: A non-transitory computer-readable medium storing code for wireless communication, the code comprising instructions executable by one or more processors to perform the method of one or more of Aspects 1-10.

Aspect 15: A non-transitory computer-readable medium storing a set of instructions for wireless communication, the set of instructions comprising one or more instructions that, when executed by one or more processors of a device, cause the device to perform the method of one or more of Aspects 1-10.

Aspect 16: A device for wireless communication, the device comprising a processing system that includes one or more processors and one or more memories coupled with the one or more processors, the processing system configured to cause the device to perform the method of one or more of Aspects 1-10.

Aspect 17: An apparatus for wireless communication at a device, the apparatus comprising one or more memories and one or more processors coupled to the one or more memories, the one or more processors individually or collectively configured to cause the device to perform the method of one or more of Aspects 1-10.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive, from a network node, configuration information that indicates a first set of random access channel (RACH) occasions (ROs) associated with half duplex operations and a set of synchronization signal block (SSB) indexes;
map the set of SSB indexes to a first subset of ROs of the first set of ROs in accordance with the half duplex operations; and
transmit, during at least one RO of the first set of ROs, a RACH message in accordance with full duplex operations in accordance with the at least one RO not being included in the first subset of ROs mapped to the set of SSB indexes.

2. The UE of claim 1, wherein, to cause the UE to map the set of SSB indexes to the first subset of ROs, the processing system is configured to cause the UE to:
map, during an integer number of mapping cycles, the set of SSB indexes to the first subset of ROs of the first set of ROs, wherein the first set of ROs includes a second subset of ROs that is not mapped to the set of SSB indexes during the integer number of mapping cycles; and
reallocate one or more ROs of the second subset of ROs from the first set of ROs to a second set of ROs associated with full duplex operations.

3. The UE of claim 2, wherein the processing system is further configured to cause the UE to:
map, after reallocating the one or more ROs to the second set of ROs associated with full duplex operations, the set of SSB indexes to a respective plurality of ROs of the second set of ROs, wherein the at least one RO is mapped to an SSB index of the set of SSB indexes in accordance with full duplex operations.

4. The UE of claim 1, wherein the processing system is further configured to cause the UE to:
receive, from the network node, signaling that includes an indication to reallocate ROs that are not mapped to the set of SSB indexes in accordance with half duplex operations to a second set of ROs associated with full duplex operations, wherein transmission of the RACH message during the at least one RO is in accordance with the indication.

5. The UE of claim 1, wherein transmission of the RACH message during the at least one RO is in accordance with an RO periodicity indicated in the configuration information satisfying a threshold.

6. The UE of claim 5, wherein the threshold is defined in a wireless communication standard.

7. The UE of claim 5, wherein the processing system is further configured to cause the UE to:
receive, from the network node, signaling that indicates the threshold.

8. The UE of claim 1, wherein the processing system is further configured to cause the UE to:
map the at least one RO to an SSB index of the set of SSB indexes for full duplex operations in accordance with the at least one RO being associated with an uplink slot, a flexible half duplex slot, or a flexible full duplex slot.

9. The UE of claim 1, wherein the processing system is further configured to cause the UE to:
map the at least one RO to an SSB index of the set of SSB indexes for full duplex operations in accordance with the at least one RO being associated with a flexible full duplex slot.

10. The UE of claim 1, wherein transmission of the RACH message in accordance with full duplex operations is in accordance with the UE being a full duplex aware UE.

11. A method of wireless communication performed by a user equipment (UE), comprising:
receiving, from a network node, configuration information that indicates a first set of random access channel (RACH) occasions (ROs) associated with half duplex operations and a set of synchronization signal block (SSB) indexes;
mapping the set of SSB indexes to a first subset of ROs of the first set of ROs in accordance with the half duplex operations; and
transmitting, during at least one RO of the first set of ROs, a RACH message in accordance with full duplex operations in accordance with the at least one RO not being included in the first subset of ROs mapped to the set of SSB indexes.

12. The method of claim 11, wherein mapping the set of SSB indexes to the first subset of ROs comprises:
mapping, during an integer number of mapping cycles, the set of SSB indexes to the first subset of ROs of the first set of ROs, wherein the first set of ROs includes a second subset of ROs that is not mapped to the set of SSB indexes during the integer number of mapping cycles; and
reallocating one or more ROs of the second subset of ROs from the first set of ROs to a second set of ROs associated with full duplex operations.

13. The method of claim 12, further comprising:
mapping, after reallocating the one or more ROs to the second set of ROs associated with full duplex operations, the set of SSB indexes to a respective plurality of ROs of the second set of ROs, wherein the at least one RO is mapped to an SSB index of the set of SSB indexes in accordance with full duplex operations.

14. The method of claim 11, further comprising:
receiving, from the network node, signaling that includes an indication to reallocate ROs that are not mapped to the set of SSB indexes in accordance with half duplex operations to a second set of ROs associated with full duplex operations, wherein transmitting the RACH message during the at least one RO is in accordance with the indication.

15. The method of claim 11, wherein transmitting the RACH message during the at least one RO is in accordance with an RO periodicity indicated in the configuration information satisfying a threshold.

16. The method of claim 15, wherein the threshold is defined in a wireless communication standard.

17. The method of claim 15, further comprising:
receiving, from the network node, signaling that indicates the threshold.

18. The method of claim 11, further comprising:
mapping the at least one RO to an SSB index of the set of SSB indexes for full duplex operations in accordance with the at least one RO being associated with an uplink slot, a flexible half duplex slot, or a flexible full duplex slot.

19. The method of claim 11, further comprising:
mapping the at least one RO to an SSB index of the set of SSB indexes for full duplex operations in accordance with the at least one RO being associated with a flexible full duplex slot.

20. An apparatus for wireless communication, comprising:
means for receiving, from a network node, configuration information that indicates a first set of random access channel (RACH) occasions (ROs) associated with half duplex operations and a set of synchronization signal block (SSB) indexes;
means for mapping the set of SSB indexes to a first subset of ROs of the first set of ROs in accordance with the half duplex operations; and
means for transmitting, during at least one RO of the first set of ROs, a RACH message in accordance with full duplex operations in accordance with the at least one RO not being included in the first subset of ROs mapped to the set of SSB indexes.
